(19) United States
(12) Patent Application Publication
(10) Pub. No.: US 2015/0269855 A1
(43) Pub. Date: Sep. 24, 2015

(54) SYSTEMS AND METHODS FOR INTERACTING WITH A VISUAL CELL

(71) Applicant: Digizyme, Inc., Watertown, MA (US)

(72) Inventor: Gaël-Christophe Garth McGill, Brookline, MA (US)

(73) Assignee: Digizyme, Inc., Watertown, MA (US)

(21) Appl. No.: 14/220,730

(22) Filed: Mar. 20, 2014

(51) Int. Cl. G09B 5/12; G09B 23/00; G09B 7/02; G09B 9/00; G09B 5/02; G09B 5/14

(52) U.S. Cl. CPC G09B 5/12; G09B 5/02; G09B 5/14; G09B 7/02; G09B 9/00; G09B 23/00

(57) ABSTRACT

The invention generally relates to systems and methods for visualizing an entire biological entity and particularly to an illustrative and comprehensive visual model of a cell. The invention provides methods for representing biological entities using interconnected visualizations to depict substantially all components and processes of the modeled entities and to tailor the depiction to an education level of an audience. Individual components are modeled from scientifically accurate data and animation techniques are used to illustrate the actions and interactions of those components that make up the biological processes. Levels of detail and presentation styles may be automatically tailored to the education level.

### FIELD OF THE INVENTION

The invention generally relates to systems and methods for visualizing substantially all components, processes, methods of study and relevant model organisms of a single cell.

### BACKGROUND

The cell is the basic structural, functional and biological unit of all known living organisms. Each cell is, itself, a complex unit of many interrelated components. To understand living systems at any educational level depends on a person's ability to assimilate the dynamic and increasingly complex interrelated processes of the cell.

Unfortunately, many learning tools try to teach the components and processes of the cell by reducing them to individual parts and teaching each part separately. Individual parts are taught outside of the context of the cell as a whole, and those parts tend to be idealized or simplified. Such an approach can lead people to perceive the cell as a series of unconnected ideas or theories, lacking in context and detail. Needless to say, such reductionist efforts do a poor job of holistically teaching the complexity of the interrelated processes occurring within the cell. In addition, knowledge about cells and the molecular constituents is often presented to students outside the context of the scientific reasoning and methods which led to their discovery.

While there have been some attempts to use computers to model whole biological systems, such as the cell, those are meant to provide predictive, quantitative research tools. For example, a project from the University of Connecticut provides differential equations for use in biochemical simulations, but does not visually portray the cell as a set of interrelated components and processes.

### SUMMARY

The invention provides a platform that visually integrates substantially all components and processes of a single cell. Systems and methods of the invention guide a person through the visualizations of the components or processes in the cell in a manner that illustrates to the person how the components and processes are connected to each other. In that manner, systems and methods of the invention contextualize the components and processes within the cell, allowing a person to view the cell as a series of interrelated components and processes, rather than a set of discrete and unconnected ideas.

Aspects of the invention are accomplished using interconnected narrative visualization modules to depict substantially all components and processes of modeled entities. The visualizations are tailored to an education level of an audience. Individual components are modeled from scientifically accurate data and animation and simulation techniques are used to illustrate the actions and interactions of those components that make up the biological processes related to the cell. Levels of detail and presentation styles may be automatically tailored to the education level. Systems and methods of the invention are not limited to the cell, and can portray an entire biological entity, such as an organ, a biological system, an organism, as well as research methods and model organisms used to study cells. Additionally, systems and methods of the invention may be used to portray a solar system, lab equipment, a machine, or other physical or natural phenomenon. The visualizations are narrative visualization in that they do not require expository prose to communicate the scientific concepts.

In certain embodiments, systems of the invention provide visualizations that can be viewed, browsed, and interacted with. Since all of the systems and sub-systems of the biological entity are included and shown with scientific accuracy, the audience can satisfy their interest and curiosity and gain an understanding of the biological entity. The audience can view the interplay of processes and components such as metabolism, reproduction, injury, infection, mutation, or recombination. The audience can thus learn how living things grow and propagate themselves and how life adapts and changes over time. Since the biological entities are modeled visually and the models are tailored to the audience's education level, biological concepts are taught holistically and effectively. Since original scientific data is used in building and animating the models, misleading simplifications are avoided.

In certain embodiments, the modeled biological entity is a cell, and the invention provides systems and methods for viewing components and processes of the cell. The cell can be represented visually, with substantially all of its components and processes included. The visualizations depicts, for example, the lipid membrane, the cytoplasm, and all the mechanics of replication, transcription, and translation. At least one of the structures is represented by a rigged model that is built with structural data and an animation rig that confers a scientifically-accurate range of motion on that structure. Components are also simulated using various methods (including Molecular Dynamics, Brownian Dynamics and other coarser-grained methods). The whole-cell can be used in a visualization product such as a computer-based interactive cell within which a user can zoom and pan to watch reactions. Systems and methods of the invention may include animations, images, interactives, games, or other such educational media.

In certain aspects, the invention provides a system for visualizing substantially all components and processes of a single cell, such as a prokaryotic or eukaryotic cell. The system includes a processor coupled to a non-transitory memory and stores a plurality of interconnected visualizations that in the aggregate represent substantially all components and processes of a single biological entity, such as a single cell. Each visualization uses at least one digital asset that visually conveys at least a portion of a component or process associated with the biological entity. At least one of the digital assets includes data representing a biological structure and rig that defines animation dynamics for the biological structure. A single digital asset may convey one entire biological concept. Even though the data representing the structures may come from disparate scientific sources (e.g., protein databank files, x-ray crystallography, and other studies), the system can present the visualizations to a user with a consistent visual style. The system can tailor at least one of the visualizations based on data received to the system related to an education level of a user (e.g., from within K-12, college, graduate, or post-doctoral). For example, the system may present at least one of the visualizations at a first level of complexity corresponding to a first educational level and at a second level of complexity corresponding to a second educational level. Tailoring may be done by concealing one or more portions based on the data related to the education level of the audience. A user may self-select a level of complexity at which to view the visualizations prior to entering the system, and may also self-select a level of complexity at each visualization. That is, a user may choose to change the level of complexity for any single visualization to simplify or increase the complexity of the visualization based on their understanding of the cellular concept they have just viewed.

The system can portray a variety of biological systems and subsystems relating to, for example, metabolism, genetics, signaling, injury and repair, and other phenomena. For example, the visualizations may depict an interaction of at least two biological entities. At least one of the visualizations may depict a signaling pathway of biomolecules in which at least two interact only indirectly. In certain embodiments, for at least one of the digital assets, the rig allows the data to illustrate a protein in a plurality of realistic conformations. The entities and the interaction will be governed by the animation rig or a simulation method. To maintain scientific accuracy, the system may leave regions the biological structure in at least one of the visualizations undefined for which scientific data is not available.

In some embodiments, the rig that defines animation dynamics will use different sets of rules for each digital asset based on surrounding biological environmental conditions (e.g., pH, T, salinity, osmolality, etc.) for a curated model within an visualization module.

The system may include or use any suitable hardware. For example, a server computer or a cloud system (i.e., multiple storage devices distributed across a cloud computing system) may house all or part of the plurality of visualizations or instructions. The visualization may be provided for viewing on an electronic device such as, for example, through a dedicated application on a tablet computer (e.g., as an “e-book” or “app”) or for viewing via a web browser on a user computer device.

Related aspects of the invention provide a method for viewing a component or process of a single cell. The method includes accessing via an electronic display device a system for visualizing substantially all components and processes of a single cell and navigating on the electronic display device through at least one of the visualizations in order to view a component or process of the cell. The system includes a processor coupled to a non-transitory memory having stored therein a plurality of interconnected visualizations that in the aggregate represent substantially all components and processes of a single cell. Each visualization uses at least one digital asset that visually conveys at least a portion of a component or process within the cell, and at least one of the digital assets in at least one of the visualizations includes data representing a biological structure and rig that defines animation dynamics for the biological structure. The system also includes instructions executable by the processor to cause the system to tailor at least one of the visualizations based on data received to the system related to an education level of a user. Educational tailoring can include navigating through the at least one of the visualizations at a first level of complexity corresponding to a first educational level and at a second level of complexity corresponding to a second educational level.

Interacting with the visual cell may include searching for and retrieving the at least one of the visualizations based on subject matter. Interacting may include using the system for performing a search for a biological concept, thus causing the system to display a subset of the plurality of interconnected visualizations that relate to the biological concept.

Interacting with the visual cell may include choosing at least one option, thereby causing the system to present a further choice, further wherein a series of choices causes the system to display a subset of the plurality of interconnected visualizations.

Interacting with the visual cell may include following a curriculum (e.g., designed to support an educational standard) in which the plurality of interconnected visualizations are organized to support an educational objective. The plurality of interconnected visualizations may be predetermined based on an educational standard. The system may select a visualization based on the educational standard. The plurality of interconnected visualizations may, for example, define a lesson plan. Interacting may include viewing information about the source of the supporting data for each visualization. Preferably, the plurality of interconnected visualizations have a consistent visual style.

Methods for viewing cellular components and processes provide tools for understanding competing hypothesis. For example, a first and a second model of a biological phenomenon may be viewed. Methods include allowing a user to change parameters such as temperature, pH, [0], pressure, salinity, and a combination thereof. The user may view a reaction of a biological system in response to the change of one or more parameter.

In some embodiments, the visualizations depict interactions of biological entities. For example, the visualizations may depict a protein in a plurality of realistic conformations, a signaling pathway comprising a plurality of biomolecules at least two of which interact only indirectly, or molecular crowding. Viewing the visualizations may be done via a user computer device such as a tablet with a viewing application or through a web browser.

### BRIEF DESCRIPTION OF THE DRAWINGS

FIG. 1 illustrates use of an electronic device to interact with a model.

FIG. 2 illustrates a level of detail in an interactive digital asset.

FIG. 3 shows a modeled cell with substantially all macromolecules present.

FIG. 4 shows a zoomed-in view from The Visual Cell at a chosen level of detail.

FIG. 5 shows an overall architecture of systems of the invention.

FIG. 6 represents a curated model.

FIG. 7 diagrams a method for providing a curated model database.

FIG. 8 illustrates components of a computer system of the invention.

FIG. 9 shows a modeling and animation tool.

FIG. 10 shows a protein model according to embodiments of the invention.

FIG. 11 depicts a low resolution model representing a reovirus sigmal protein.

FIG. 12 illustrates one method of rigging a model.

FIG. 13 shows a rigged model.

FIG. 14 shows a motion of a model based on the rigging.

FIG. 15 illustrates protein dynamics at four different levels.

FIG. 16 diagrams a method of building the visualization digital assets database.

FIG. 17 shows a DNA/chromatin strand.

FIG. 18 illustrates use of a modeling product to prepare a model.

FIG. 19 shows the layers of a molecular visualization as would be represented within a digital asset.

FIG. 20 presents a digital asset based on a curated model.

FIG. 21 shows membrane modeling with automated control over the level of detail of the meshed components.

FIG. 22 illustrates bringing individual curated molecular models into a membrane model for a packing simulation using collision proxies.

FIG. 23 shows use of an electronic device to view a visualization product or digital asset.

FIG. 24 diagram a method for constructing a visual digital asset.

FIG. 25 depicts an interface for using systems of the invention.

FIG. 26 shows creating custom visualizations within the Visual Cell.

FIG. 27 illustrates a detail of a membrane.

FIG. 28 shows an H-bond network.

FIG. 29 illustrates chemical structures.

FIG. 30 shows a phospholipid in a membrane.

FIG. 31 shows phospholipids.

FIG. 32 illustrates a structural difference.

FIG. 33 illustrates an Archaeal monolayer.

FIG. 34 illustrates types of transport.

FIG. 35 shows an overview of membrane-enclosed organelles.

FIG. 36 shows endo- and exo-cytosis.

FIG. 37 shows a hemi-fusion intermediate.

### DETAILED DESCRIPTION

The invention generally relates to systems and methods for providing a narrative visual depiction of substantially all components and processes related to an entire cell, such as a prokaryotic or eukaryotic cell. The components and processes are not limited to being inside of a cell, and systems and methods of the invention also show extracellular components and events in which the cell interacts with extracellular entities, such as bacteria, viruses, antibodies, proteins, and other biological molecules. The narrative visualizations in the aggregate will generally include substantially all of the components and processes associated with a single cell, different cell types, methods for studying cells and relevant model organisms from which cells are isolated and studied.

The Visual Cell is presented using a plurality of interconnected digital visualization digital assets. The visualizations are made using curated models that visually convey parts of components or processes associated with the cell. The visualization digital assets may be animations, one or more stills, interactive games, etc. In certain embodiments, the visualization digital assets can be made using rigged models, in which a rigged model includes data representing a biological structure and a rig that defines animation dynamics for the biological structure. In certain embodiments, the visualization digital assets can be made using simulations, in which the model's biological structure and conformations is derived through various methods of simulation. The visualizations can be tailored to an education level of a user or a chosen level of complexity. Using the plurality of interconnected visualization digital assets, cellular phenomena are depicted and communicated in series of visual mini curricula. The number and order of digital assets within these mini-curricula can be customized by instructors thereby improving on the rigid ‘Table of Contents’ structure characteristic of print textbooks. Also, the modularity of the system lends itself to a digital badging system whereby students, as a result of their performance on embedded visual assessments, will receive and display digital badge credentials within the VisualCell to demonstrate mastery of biological concepts.

Embodiments of the invention may provide The Visual Cell, an online, immersive and interactive learning environment for the most challenging concepts in the life sciences (including but not limited to cell and molecular biology, biochemistry, developmental biology, immunology, virology, neurobiology, physiology, experimental techniques and associated model organisms), concepts that are most effectively conveyed through visualization. The system is organized into visual mini-curricula and topic-specific collections and built upon a digital library of models, customizable imagery, animations, interactives and assessments. The system offers various learning paths through the material that tailor the materials to various educational levels including AP-Biology, introductory and advanced college biology topics. Data-driven scientific visualization digital assets are also available to scientists, educators and publishers in the context of topic-specific collections. A eukaryotic cell (e.g., animal, plant, or fungi) may include a nucleus, chromosomes, ribosomes, microtubules, microfilaments, centrioles, cilia, flagella, and other structures. An animal-based cell may include organelles such as the nucleus, the nucleolus (within the nucleus), rough and smooth endoplasmic reticulum, Golgi apparatus, mitochondria, vesicles, lysosomes, centrosomes, centrioles and other such structures. A plant cell may include a cellulose cell wall, a large central vacuole, and chloroplasts, as well as organelles. Fungal cells my include chitinous cell walls. A bacterial cell will typically include a cell wall (e.g., thick peptidoglycan for Gram+bacteria), a plasma membrane, such extracellular structures as fimbriae and pili, S-layers, glycocalyx, and flagella. Intracellular bacterial components include the bacterial chromosome and plasmids ribosomes and other multi-protein complexes, intracellular membranes, cytoskeleton, as well as nutrient storage structures such as inclusions, vacuoles, or other micro-compartments. Archaea cells may have a lipid monolayer membrane.

Processes in a cell that may be included in a visual cell include molecular transport, DNA replication, reproduction, protein synthesis, metabolism, and signaling Particular processes that may be included are exocytosis, endocytosis, phagocytosis, mitosis, meiosis, transcription, translation, ATP synthesis, electron transport, dinucleotide redox, photosynthesis, a great variety of bacterial metabolic pathways (e.g., methanogenesis, aerobic respiration, etc.), chemical signaling, and receptor-mediated signaling, among others. Components and processes of cells may be found discussed in Cooper and Hausmann, 2013, The Cell: A Molecular Approach, 6th Ed., Sinauer Associates, Inc., 832 pages, and in Karp, 2013, Cell and Molecular Biology: Concepts and Experiments, 7th Ed, Wiley 864 pages, the contents of each of which are incorporated by reference.

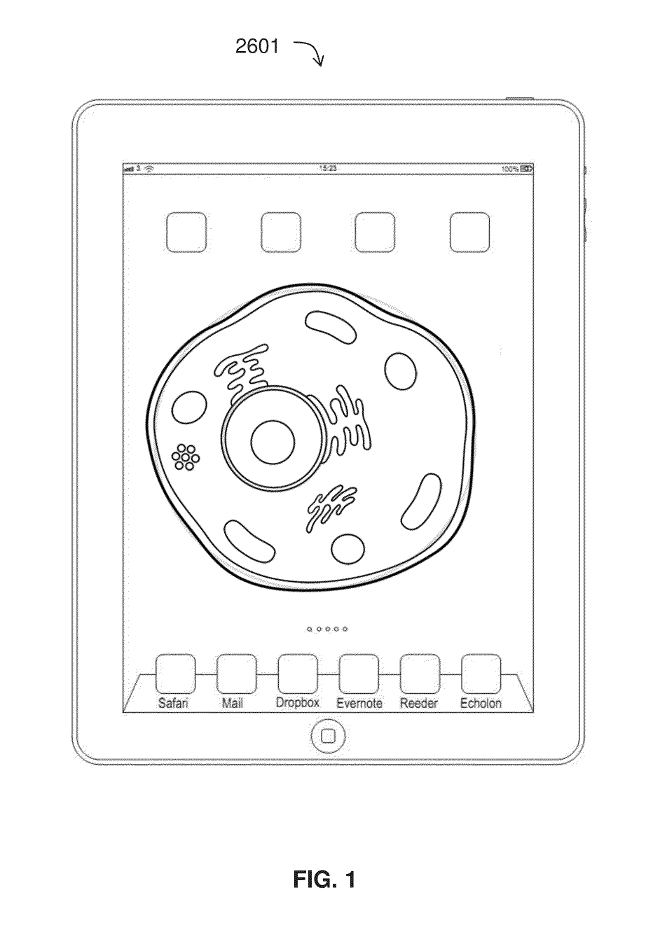

FIG. 1 illustrates an embodiment of the invention showing one of several options for users to interact with the Visual Cell as presented on the display of an electronic device 2601. Device 2601 may be used by an audience member (e.g., student or other person) to interact with the cell. Interaction can include, for example, zooming in to examine features of interest, triggering metabolic phenomena and simulations, or selection of graphical navigational hotspots that launch educational digital assets. While presented here as a cell, systems and methods of the invention can be used to provide models that cover a substantial entirety of a variety of complex natural systems, including, for example, organs, whole organisms, ecological concepts, and other systems. In certain embodiments, methods and systems of the invention are used to provide a visual cell.

The Visual Cell uses interconnected visualization digital assets to represent components and processes of the cell. The visualization digital assets may be animations, one or more stills, an interactive game, and interactive animation, etc. Individual components, such as proteins or other macromolecules, for example, may be depicted using rigged or simulated models. A rigged model—discussed in greater detail below—includes geometry representing some depicted structure and a rig. A rig is known in the art of 3D animation and generally refers to an organized system of deformers, expressions, and controls applied to an object so that it can be effectively animated. Rig has been used in the animation arts to include a deformation engine that specifies how movement of a model should translate into animation of a depicted entity based on the model. A rig provides software and data used to deform or transform a neutral pose of a model into a specific active pose variations. By having animation software manipulate a rig incorporated to a model, animated movement of the model is achieved. Rigging may sometimes be referred to as character setup or animation setup. A detailed discussion of creating rigs may be found in sources such as O'Hailey, 2013, Rig it Right! Maya Animation and Rigging Concepts, Focal Press, Burlington Mass., 280 pages; Palamar and Keller, 2011, Mastering Autodesk Maya 2012, Wiley Publishing, 950 pages (esp. chapters 5 and 7); and Sharpe, et al., 2008, In silico: 3D Animation and Simulation of Cell Biology with Maya and MEL, Elsevier Morgan Kaufman, Burlington, Mass. (622 pages), the contents of each of which are incorporated by reference. Rigging and rigs are discussed in U.S. Pat. No. 8,253,745 to Hahn; U.S. Pat. No. 7,782,324 to Goldfarb; U.S. Pub. 2013/0235046 to Lanciault; U.S. Pub. 2011/0098113 to Lanciault; U.S. Pub. 2009/0295793 to Taylor; U.S. Pub. 2009/0091563 to Viz; and U.S. Pub. 2006/0109274 to Alvarez, the contents of each of which are incorporated by reference.

A curated model which includes a rig based on joints/bones or particles, may be made using an animation environment such as Maya. Within Maya, a rig may be saved as a file that includes a reference to the rigged geometry file. Rigged models are used in the digital visualization digital assets that make up The Visual Cell. The Visual Cell can be presented on an electronic display to allow a user to zoom in or out and to focus on areas of interest, to study particular phenomenon, and to see individual components of a cell with the context of the entire cell as a living organism.

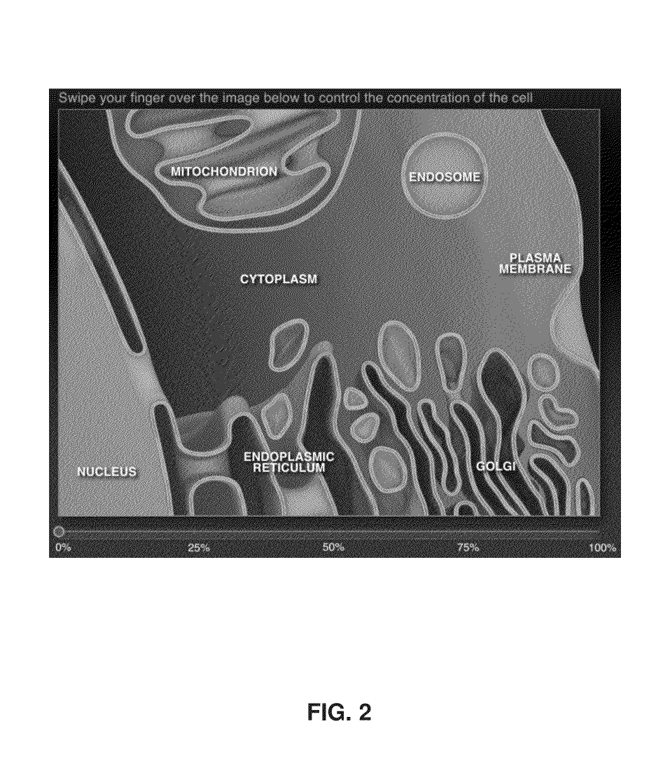

FIG. 2 illustrates a zoomed-in level in which a user may set a level of detail, or concentration, to be included in the scene. A slider is depicted at the bottom of the screen for populating the cellular environment with a desired level of detail. In some embodiments, at the lowest level of detail, cellular mega-structures such as the endoplasmic reticulum and endosymbiotic organelles are depicted.

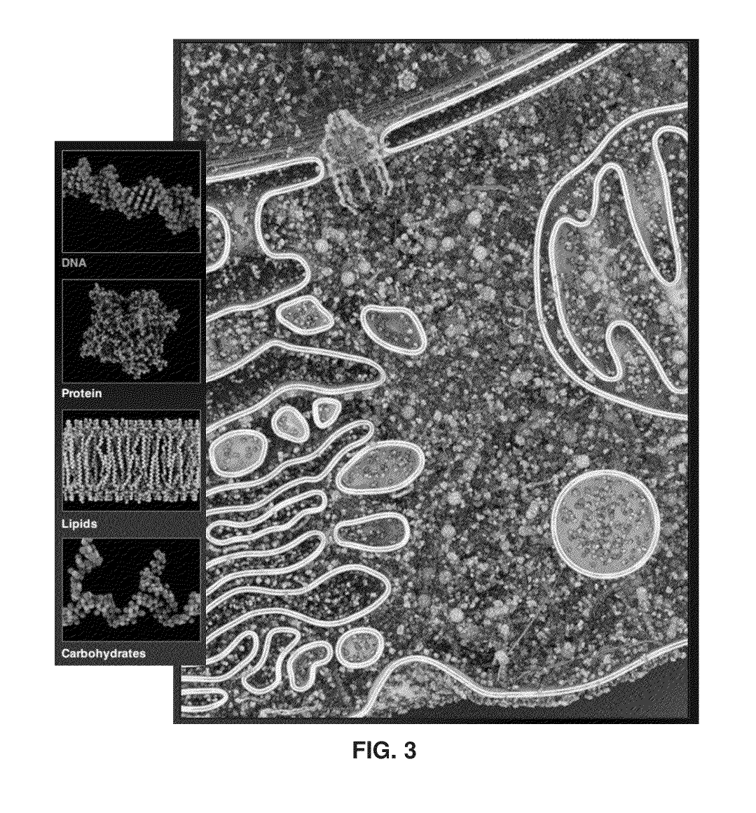

FIG. 3 shows a cellular environment in which a user has increased a level of complexity and the cell is depicted with substantially all macromolecules present. In the presented example, a menu is set off to the side to show, for example, how to select and highlight individual molecular families within the cellular environment using color-coding. For example, the menu can indicate that all nucleic acids are blue all proteins are red, all lipids are yellow, and all carbohydrates are green. Additionally, the menu can be used to toggle the appearance of certain classes of macromolecule on and off. Since each macromolecule is represented using a rigged model 121 built on data that is sourced from primary scientific research, the actions and interactions depicted within the cellular environment have a high degree of scientific accuracy.

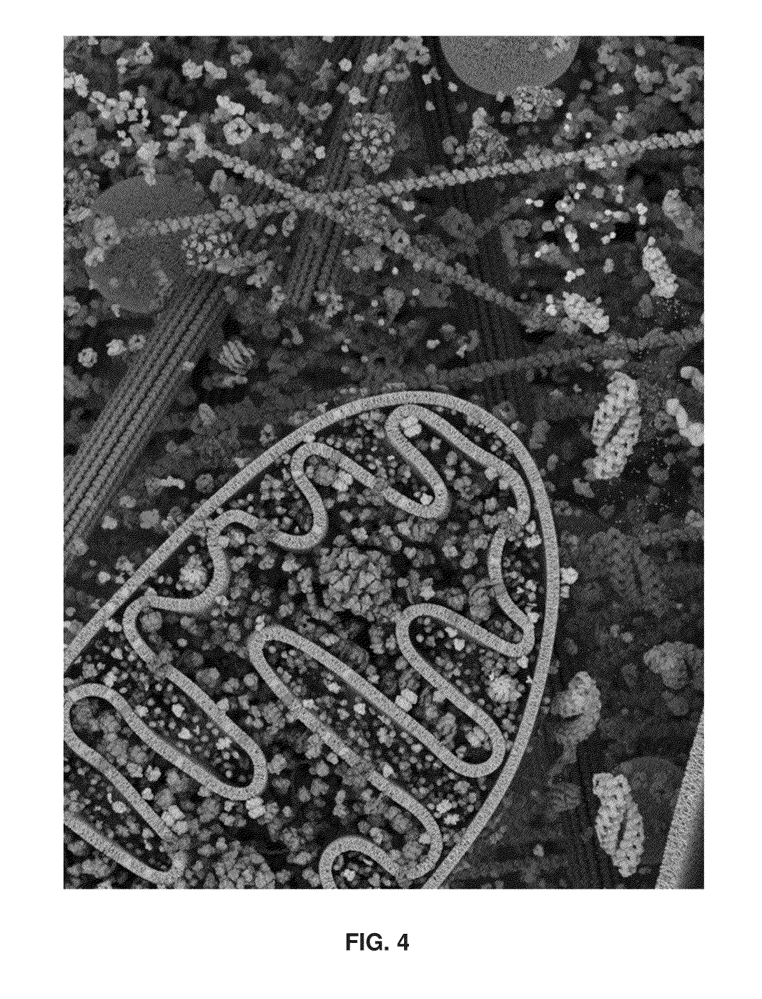

FIG. 4 shows a zoomed-in view of a cellular environment that includes a close-up cross section of a mitochondrion within the cytoplasmic environment that it inhabits. The circular mitochondrial genome can be viewed by the user as can the functioning components of the electron transport chain. A user could choose to zoom in on, for example, an ATPase to observe how that piece of cellular machinery exploits a proton concentration gradient to cause rotation, which mechanical energy is transferred by phosphorylating ADP to ATP, a universal store and source of energy. Thus this visualization digital asset can be used to understand how our endosymbiotic history enables aerobic respiration to provide the energy we use to live and grow. Each component within the visualization digital asset may be represented by one or more rigged models. Each rigged model can include information about the source of the supporting data for that model. Use of The Visual Cell can include viewing the source of the data (e.g., hover a mouse over a protein and see a pop-up listing that protein's PDB accession number, a citation to a publication describing the structure, as well as visualization methods used to curate, animate, simulate the protein). When educationally appropriate, the plurality of interconnected visualizations can be shown with a consistent visual style.

The invention provides methods of interacting with The Visual Cell to satisfy different interests and objectives. Different objectives such as open curiosity versus seeking a specified learning objective may be best served by different interaction methods. Systems and methods of the invention provide for differing interaction approaches that include visual searching, “choose your own adventure” interactions, interactions guided by educational standards, or planned scientific modeling.

Searching provides a method of interacting with The Visual Cell as a reference tool. A user may search for and retrieve one of the visualization digital assets based on a specific topic. For example, a user may perform a search for a biological concept (e.g., “Okazaki fragments”), thereby causing the system to display a subset of the plurality of interconnected visualization digital assets that relate to the biological concept (e.g., replication).

A “choose your own adventure” style interaction may be used to interact with certain visualization digital assets of The Visual Cell. This interaction style can include choosing at least one option, to cause the system to select at least one visualization digital asset for display. The selection may proceed down a decision tree. Choosing the first option may cause the system to present a further choice, and so on, leading the system to display a final subset of the plurality of interconnected visualization digital assets. This style of interaction may be suited to building a game based on The Visual Cell. It may be found that the choose-your-own-adventure style is also well suited to a tool for casual browsing by the interested lay public who are curious to explore the cell in an open way.

Educational objectives may be used to structure an interaction with The Visual Cell. For example, interacting with The Visual Cell may specifically be guided to track a curriculum or a standards-based educational plan. While the entire Visual Cell may be available in memory, certain visualization digital assets are selected for display by the system based on an educational standard. An educational standard (e.g., as published by a governing entity) may be used as a template for building a series of visualizations through The Visual Cell such that interacting with The Visual Cell through that series of animations teaches those educational objectives embodied by the standard. Educational objective interaction further includes tailoring the presentation of The Visual Cell to an educational level or objective. For example, one user may navigate through some of the visualization digital assets at a first level of complexity corresponding to a first educational level of that user. Those visualization digital assets could also be presented at a different level of complexity corresponding to a different educational level. In this way, The Visual Cell product may have application in both the high school and the college classroom. Additionally or alternatively, The Visual Cell may adapt itself as a tool to a single user as that user progresses in their understanding of cellular phenomenon. Moreover, The Visual Cell may adapt its presentation (e.g., level of complexity) in response to the results of embedded assessments (discussed in greater detail below).

Modeling or testing an idea in silico is provided for via interacting with The Visual Cell. For example, The Visual Cell can be used to present two competing models of a biological phenomenon. A user may change parameters of the cellular environment to observe how the cell responds (e.g., at what extracellular osmolality will this cell burst?). Such parameters include, for example, temperature, pH, [O2], pressure, salinity, viscosity, and others.

User customization may be included in The Visual Cell and its component digital assets.

In certain embodiments, The Visual Cell tailors the materials that it presents to its users in several different ways.

Depending on login info and therefore user account, we know whether the user is an instructor, student in HS/AP-Bio, intro college, college upper level, graduate student or scientist.

Each digital asset within The Visual Cell database is ‘rated’ by curricular and complexity level. Therefore while a set of 20 digital assets might cover a specific topic like ‘Biomembranes’, only 5 of them would be rated/tagged for inclusion in an AP-Bio learning path/classroom, 12 would be tagged for use in Introductory Biology and the remaining 3 would be advanced digital assets (for advanced students or scientists).

In addition to complexity level, subsets of widgets can also be grouped according to another cross-cutting themes such as evolution or topics that align themselves with educational standards. For example, an instructor may want to assemble a set of widgets that focuses on evolutionary aspects of biology and thereby find and assign widgets that are tagged with this underlying theme, but belong to many different specific mini-curriculum topics (i.e. Biomembranes, Gene-to-Protein, Cell Death Machinery, others). Other instructors may want to have a view of widgets that more strictly follow some educational standards and whose topics are aligned with the NGSS (Next Generation Science Standards) or Common Core standards for example.

By default, within a particular mini-curriculum, a specific ordering of digital assets is offered by The Visual Cell (i.e. a ‘learning path’ through the material of that mini-curriculum). This order of widgets (as noted above it could be 5 or 12 or 20 depending on level of the audience), however, can also be customized by the instructor. The UI of The Visual Cell allows instructors to inspect a library of all widgets within a mini-curriculum (represented with small icons and titles), individually drag-and-drop these widgets onto a custom learning path template and then assign this new custom order to their virtual classroom.

Customization in The Visual Cell can also be found at the level of individual digital assets and their functionalities. For example, digital assets that allow students to create their own custom ‘recipes’ for assembling a molecular landscape image are unique in that the output of these activities are completely custom to each student (no two images generated by these digital assets are likely to ever be the same since the student recipe drives a simulation to position molecular components into the 3D scene and resulting image).

Each student, while experiencing instructional and assessment activities within The Visual Cell, collects various types of materials to embed within their own digital study portfolio. The study portfolio is also used by the student to write notes and associate them with collected materials as preparation for class tests (′collected materials' in The Visual Cell might be a snapshot from an instructional movie, or a custom image or model created within an assessment digital asset or the result of a simulation launched by the student). Instructors are able to review students' digital study portfolios and make edits (or suggest edits for the students to make). The creation and review of these study portfolios is a valuable assessment activity in itself since it gives instructors a good sense of what the student understands about the material as well as any misconceptions they may have. Since each student's activities, associated notes and assessments is unique to that student, the study portfolio is another example of a tailored experience within The Visual Cell.

Additionally, visual assessment may be included in The Visual Cell and its component digital assets.

Current modes of student assessment are limited in the scope of concepts that they can test. Banks of multiple choice questions remain an easy and effective way to ascertain certain kinds of factual understanding, but there are many aspects of the complex information presented to students that cannot adequately be assessed with such testing methods. Indeed, typical forms of assessment-like multiple choice questions (rarely with any reference to visual materials as part of the question) or essay-type questions remain a narrow window through which instructors can discern the strength and robustness of student knowledge. At the same time, rich visual media are increasingly being used to impart complex concepts to students. These include carefully designed diagrams or images, multi-part interactives, immersive and photorealistic movies and even educational mini-games that engage students to participate in tasks and discoveries that drive learning. There is a disconnect between these increasingly rich visual experiences and the nature of the follow-on assessments that test students' understanding of the concepts presented. An analogy would be to ask a student to provide a rich, textured account of a Shakespeare sonnet or a Bach fugue using either a Kindergarten vocabulary or a three-note repertoire, respectively. In short, current forms of assessment no longer match the breadth of instructional techniques and visuals used by instructors and this limits our ability to offer customized learning paths for students.

Visual assessment paradigms within the digital assets of The Visual Cell leverage the richness of the varied forms of visual media that we use for instructional purposes. They offer a unique opportunity to reuse and cast in a different light visual activities driven by students that tie back to the instructional materials and therefore offer a more consistent experience to the student. Example of such visual assessment digital assets may include any of the following.

In one possible digital asset, the interactive labeling of a figure or diagram by a student (a visual similar or identical to those they have previously encountered in an instructional digital asset but that they are now challenged to label, annotate and/or comment on).

A 3D interactive digital asset can ask students to manipulate and orient a 3D model in space (whether it be a molecule, tissue, organ, organism or other instruments). Assessment requires students to select specific angles that showcase certain characteristics of the model (in the case of a molecule/enzyme, for ex, the assessment may require the student to orient the molecular such that the active site is facing the camera).

An interactive digital asset challenges students to re-order a jumbled sequence of visuals (either static frames/slides or movie segments) in order to assemble the proper movie of an ordered process. This type of activity reinforces the concepts by revisiting the visual materials previously used in an instructional digital asset but also tests the student's understanding of the chronological order of a complex process (for example, given 6 movie clips across the gene-to-protein continuum, the student is asked to order them such that the complete movie proceeds from gene transcription, RNA maturation and splicing, nuclear export, translation and protein folding). When properly assembled (along with any supplemental commentary and annotations captured from the student), the movie is integrated within a personalized digital study portfolio—a continuously updated and instructor-moderated document that students use in preparation for larger exams throughout the course.

One possible digital asset provides free-hand annotations of existing visuals (e.g., ‘circle the cytoplasmic domain of this protein’) Implemented as ‘guided sketching’ activities, the freedom of such assessment provides instructors with an even broader window on what students are thinking (compare, for example, the results of the ‘Picturing to Learn’ NSF project led by Felice Frankel).

A ‘create-your-own-study-figure’ interactive digital asset can be included that lets students create their own custom, professional-quality image or simple animation and save it as part of their online study portfolio. For example, a list of molecular ingredients is presented to student along with a challenge: ‘model a red blood cell membrane’ (these challenges are based on (i) the instructional materials previously presented and (ii) tailored to the curricular level. Student has the ability to selectively include individual ingredients along with their relative amounts and submit this recipe to The Visual Cell via the web UI. Leveraging our proprietary 3D tools running on the cloud (Molecular Maya), the student's recipe is used to assemble and, in some cases, simulate a custom 3D model in an automated fashion. This complex model is then automatically rendered into a beautiful image that is sent back to the student via the web UI. Such custom scientific images and short animations are not only creative visual assessments where students have control over their creation but, in doing so, the system tests their understanding of the components and interactions within a biological system like a cellular membrane or a molecular complex. The resulting imagery can be shared and critiqued within either a class-related social network (online) or used in the context of a flipped classroom setting. Constructive criticism from the instructor or classmates drives a second round of editing by the student (via the same web UI which has saved their original recipe). The final image or short animation can then be interactively labeled by the student within The Visual Cell UI and becomes embedded within the student's online study portfolio.

Fundamentally, visual assessment harnesses the benefits of visual thinking in students. It broadens the scope of assessments because many more concepts (and misconceptions) can be gleaned from students through the use of a multitude of visuals, whether static, interactive or custom-created by students themselves. The richness of visual assessment activities also has the potential to change the paradigm of ‘learn, learn, learn, learn, learn, asses’ model to a demonstratively more effective type of instruction (in terms of understanding and long-term retention) which follows the ‘learn, asses, learn, asses, learn, asses’ model. The latter begins to blur the distinction between learning and assessment phases as a result of the rich experience provided by creative visual assessments.

The visual assessment embodiments are included but not limited to: 1) allowing student to visually modify existing imagery (either through labeling, additional sketching, selection or other activities), 2) order sets of still images or image sequences (animations) to properly sequence a temporal process, 3) create their own custom imagery within the system, control parameters that impact the quantitative and/or qualitative output of simulations and game-like interactives.

Digital assets of the Visual Cell not only allow instructors to monitor student progress and understanding within and across individual assets, but they also enable/guide them in implementing asset-based activities in a flipped-classroom context. For example, aspects of certain digital assets are designed to be used by students at home for instructional purposes, while other aspects of these assets are designed to facilitate classroom-based discussions and problem solving.

The Visual Cell offers a new level of transparency to users that is realized at two levels: a) the sources used for creation of content in all form (structural, dynamic or other) and b) the process and methodology used to create the visualization itself.

The modularity of the Visual Cell platform enables rapid updating of content based on changing scientific data or shifting theories within the scientific community. The system designed to allow revisions within digital assets as well as deletion or creation of entirely new digital assets.

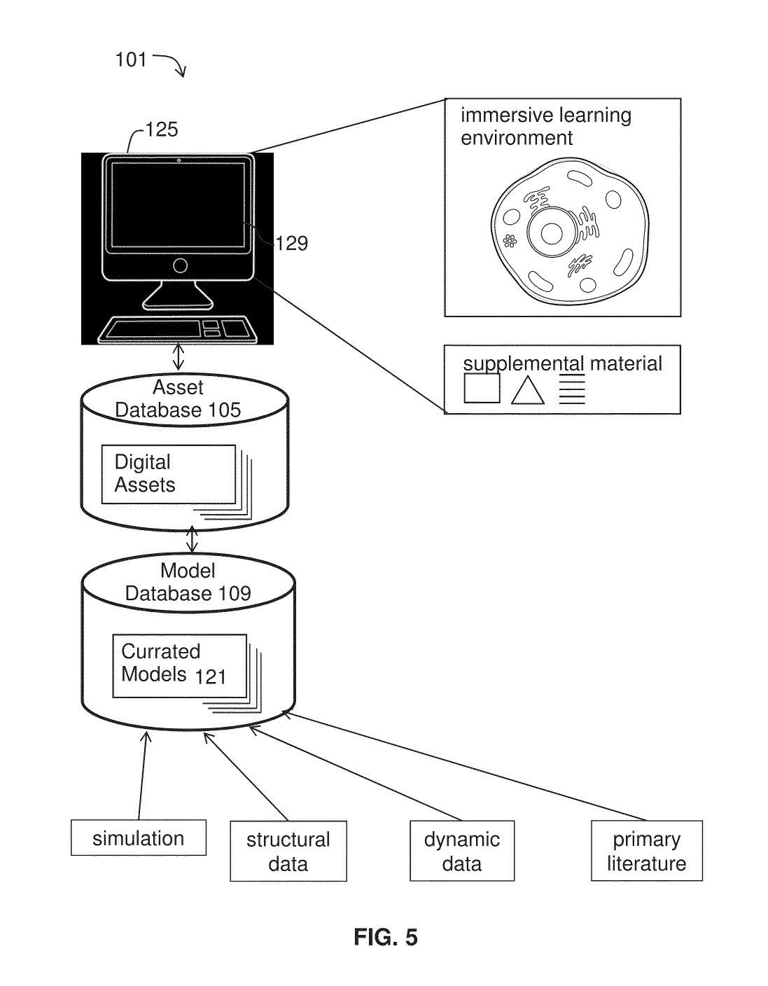

FIG. 5 generally illustrates an architecture of systems of the invention that can be used to provide The Visual Cell. The Visual Cell generally includes a plurality of digital visualization digital assets. The Visual Cell, and the included plurality of digital visualization digital assets, may be made by drawing on an asset database 105. Digital assets within digital assets database 105 generally refer to an image, an animation, an interactive diagram, a mini-game, or such a piece of digital media. Generally, a digital asset will include one or more curated models from a curated model database 109.

Curated database 109 generally includes one or a plurality of rigged curated models 121. A curated model may generally be understood to refer to a multi-dimensional (e.g., 3D molecular) model that integrates scientific information (structural, dynamic, and other) that is ‘ready to use’ for visualization. Curated models 121 may be built de novo or by sourcing scientific data from a suitable source such as, for example, a simulation, structural data (e.g., from protein data bank), dynamic data, or the scientific literature. Curation includes selection or building of a model and rigging the model to produce rigged model 121. Rigging a model, whether using a method such as bones and joints or particles, can make a model ‘ready to use’ for visualization.

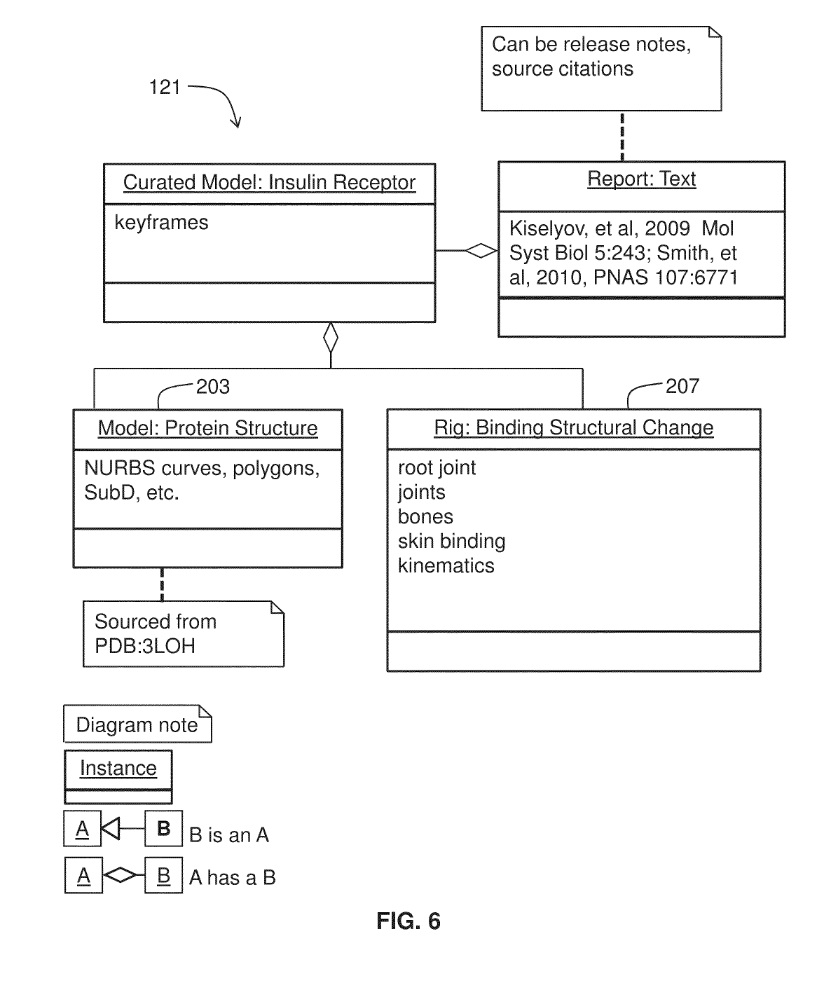

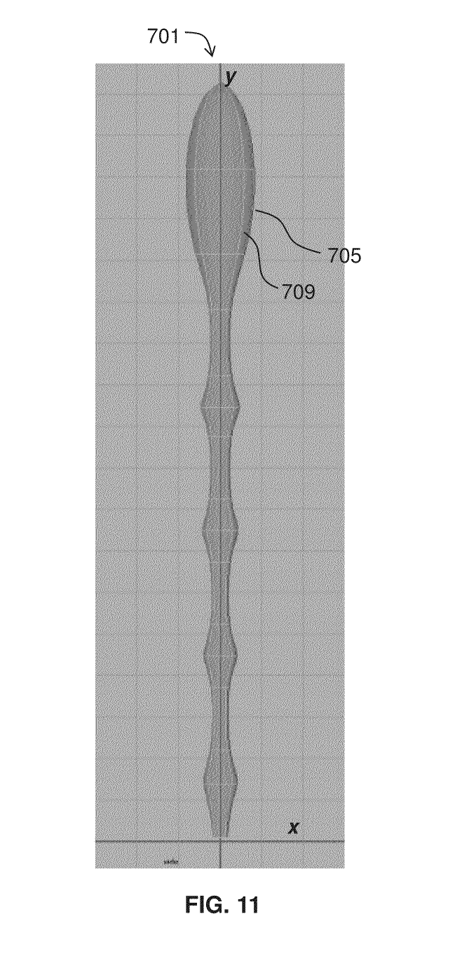

FIG. 6 gives an exemplary structure of a rigged model 121. A rigged model 121 will generally include a model 203 and a rig 207. Rigging with joints and bones is discussed in greater detail below (e.g., with respect to FIGS. 11-14). Model 203 includes data representing a structure, often in the form of a geometry file. Any suitable model 203 may be included in a rigged model 121. For example, in some embodiments, model 203 is a geometry file of a format suitable for creation, viewing, and manipulation within modeling or animation software such as, for example, Autodesk Maya. Any suitable animation software may be used. Exemplary animation software products include those provided by Cinema4D Studio by Maxon Computer Inc. (Newbury Park, Calif.), Blender supported by the Stichting Blender Foundation (Amsterdam, the Netherlands), and 3DS Max 2014 by Autodesk, Inc. (San Rafael, Calif.).

Any suitable method may be used to obtain a geometry file. For example, geometry files can be imported from sources such as structure database, created de novo within a modeling environment, or built of raw data obtained from an experiment or assay. The structures to be represented by geometry files may be predicted by computational algorithms, or may represent real structures determined by spectroscopic methods such as X-ray crystallography or nuclear magnetic resonance (NMR).

One exemplary approach to obtaining geometry files includes the use of a molecular graphics application such as Chimera or PyMOL. Other suitable applications may include Astex Viewer, UGENE, DS Visualizer, Swiss PDB Viewer, Interchem, VMD, RasMol, Jmol, Python Molecular Viewer, Coot, MDL Chime, MolSoft Viewer, and other such products. Such a program can be used to open raw structural data, such as a set of coordinates from a protein databank (PDB) file and to export the structural data in a format suitable for use in a modeling environment.

A PDB file embodies a format for representing actual 3D structures of biological molecules. The PDB format is widely accepted as a standard in the biosciences. The molecules may include protein or a nucleic acid (RNA or DNA), a complex of several proteins, a complex of protein with nucleic acid, or any of these in a complex with small molecule ligands such as drugs, cofactors, metal ions, etc. The 3D structure of the macromolecule is usually determined by X-ray crystallography, but other spectroscopic methods, such as NMR, are occasionally employed. The Protein Data Bank currently archives over 90,000 PDB files of macromolecular structures, which are freely available to the public. See, e.g., Berman, et al., 2000, The Protein Data Bank, Nucl Acids Res 28(1):235-242.

The PDB format includes ASCII text giving XYZ coordinates for atom locations, as well as data on atom-to-atom bond connections. Other information typically included are protein amino acid sequence and secondary structure, crystallographic space group, and general comments on the biological role of the protein. Molecular graphics applications such as Chimera or PyMOL by design readily import PDB files.

The structural data can be exported from the molecular graphics application (e.g., Chimera, PyMOL) to generate geometry files. These may be exported as Virtual Reality Modeling Language (VRML) and then converted to OBJ format (a common data format for 3D data) before being imported into a modeling program such as Maya. Additionally or alternatively, scripts can be used to prepare a geometry file from a set of coordinates using, for example, Maya Embedded Language (MEL) or the Python programming language. The method to use may relate to what will be done with the geometry once inside Maya. In certain embodiments, large PDB datasets are brought into Maya as geometry files using the multi-scale model feature of Chimera.

In some embodiments, structural data can be obtained for modeling using the product Molecular Maya Toolkit, sometimes referred to as mMaya or Molecular Maya. Molecular Maya is a free software toolkit that extends the capabilities of Maya by allowing users to import, build, and animate molecular structures. Molecular Maya includes the functionality to open PDB-formatted files. Molecular Maya works with Maya 2011, 2012, 2013, and 2014 and adds a molecule-shaped icon to the Maya environment. Molecular Maya includes (or adds to Maya) UI elements for opening PDB files. Molecular Maya can import the text-formatted native PDB file.

Typically Maya, or Molecular Maya, will present an empty scene upon opening. Once a PDB file is imported, it can be viewed as atoms. However, Molecular Maya can transform it into a geometric structure, with options for selecting levels of resolution. Once imported, the geometry file provides the model 203 for a rigged model 121.

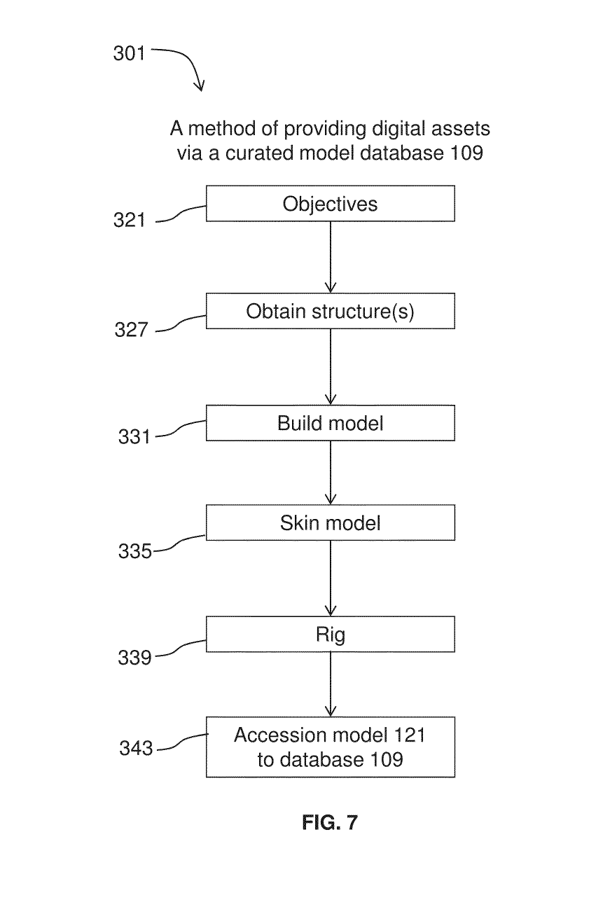

FIG. 7 diagrams a method 301 for curating a molecular model. Method 301 operates preferably within the context of determining an objective 321 such as assembling a full-length protein molecular model from smaller or incomplete pieces of structural data. A computer system is used to obtain 327 structure data. Structure data can be obtained from a scientific assay such as x-ray crystallography, either directly or once published (e.g., from PDB files). The structure is used to build 331 a model 203, typically a geometry file. The model may optionally be skinned 335 with textures or shaders.

The geometry is rigged 339 with a rig that defines animation dynamics for the structure such that a range of motion for the rigged model is defined (i.e., for the depiction of the underlying structure in a downstream animation). Each curated model is accessioned 343 to curated model database 109. Access to these rigged, digital models 121 is then provided for use in illustrating scientific concepts. Access may be provided through, for example, the visualization digital asset database 105, in which one or more rigged model 121 may be bundled into visualization digital assets.

One of skill in the art will recognize that digital asset database 105 and curated model database 109 may be operated by interaction through a computer system to perform methods such as method 201. Any suitable computer system may be used.

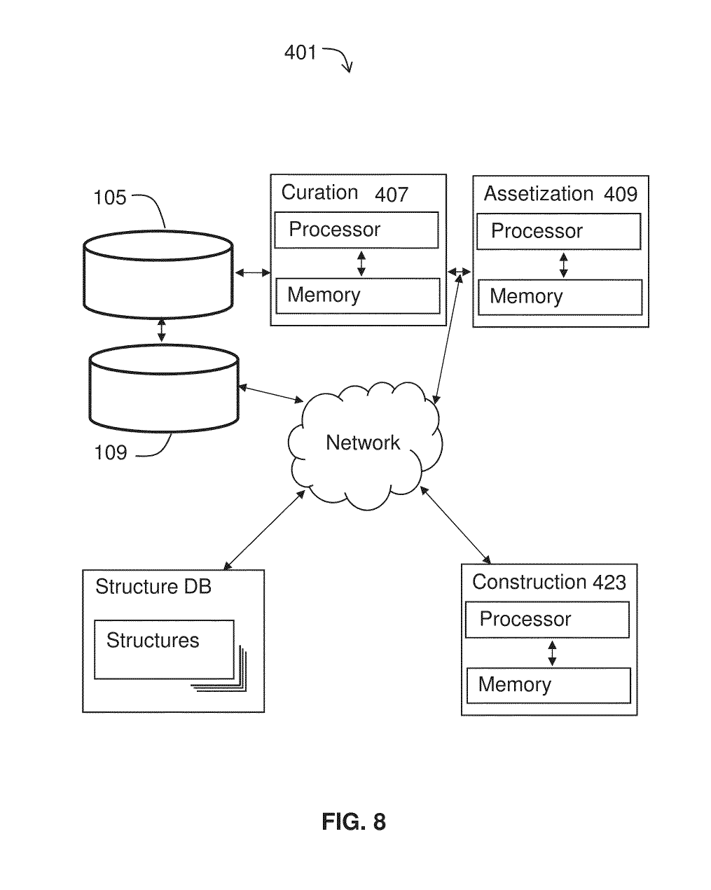

FIG. 8 illustrates components of a computer system 401 that may be included in systems of the invention. Generally, digital asset database 105 operates with the ability to connect to and pull from curated model database 109. A curation computer device 407 is used to create curated models and populate model database 109. Computer device 409 is used to build digital visualization digital assets that use the rigged models 121. One of skill in the art will recognize that curation computer device 407 and computer device 409 are being described in terms of their roles. These roles can each separately be performed by using one or any number of different computers and can even both be performed through the use of a single computer. A computer generally refers to a device that includes a processor coupled to a non-transitory memory and an input output device. Computers of system 401 may communicate with one other via a network—broadly referring to the hardware used in transferring signals between computers. Network 401 may be taken to include internet hardware such as telephone lines, cell towers, local switches and routers (e.g., LINKSYS products by Cisco Systems, Inc. (San Jose, Calif.), Ethernet cables, Wi-Fi cards, network interface cards, and other such device. Network 401 may be understood as providing the ability to obtain structures from a structure database such as, for example, protein databank. As will be discussed in greater detail below, system 401 provides a construction computer device 423 for constructing a visual product (which device may be provided by one or more separate, dedicated devices or may be provided by the same one or more computer device providing either or both of curation computer device 407 and computer device 409). It will be appreciated that in some embodiments, curation computer device 407 and computer device 409 are employed in a production environment, wherein skilled scientist-animators rig models and build assets. In some embodiments, curation method 301, as depicted in FIG. 7, is performed using curation computer device 407. In general, the output of curation method 301 will include at least one rigged model 121.

In certain embodiments, construction computer device 423 refers to the personal computer (e.g., tablet, laptop, or desktop) used by a consumer to log into system 401 and initiate a request to interact with The Visual Cell. The Visual Cell generally includes substantially every component of a single cell, and each may be modeled using a rigged model—i.e., with a structure and a rig.

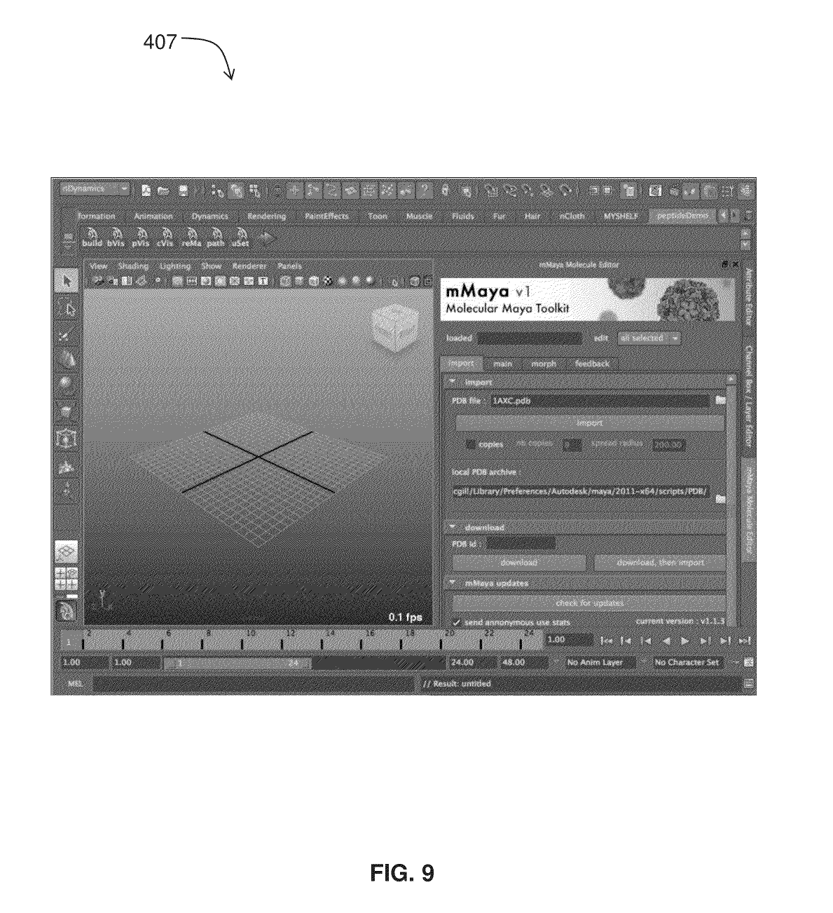

FIG. 9 shows a modeling and animation tool as presented by system 401, i.e., a screenshot from a modeling and animation software product (e.g., as implemented on curation computer device 407). In some embodiments, the animation software is provided by Molecular Maya (e.g., mMaya v 1.0) in combination with Autodesk Maya and is used to rig a model such as may be obtained from a PDB file. System 401 can be used to create models, rig models, and create visual products such as animations that use those models.

Production of The Visual Cell is provided for by the separation and specialization of tasks afforded by modeling and animation environments such as Maya. For example, while a model—or geometry file—can be rigged, and the rig will typically include a reference to the geometry file, it will be appreciate that a rig can be changed to reference a different model. That is, one of the valuable properties of a rig is that it can be used with one geometry then another. For example, a modeler could make a “quick and dirty” geometry and hand it off to the rigger. The rigger could build a rig using that geometry while the modeler works on a more detailed geometry. However, as used within an animation, a rig will generally reference one model (i.e., the geometry that it rigs).

In some embodiments, system 401 includes Maya and models 203 are represented through the use of Maya's dependency graph. Geometric objects, as well as data processing units such as transforms and shaders, are encapsulated as nodes. These nodes are connected through their attributes into a network that is known as the dependency graph. Each node is dependent upon another, which includes that as the dependency graph is dynamically updated, changes to any node automatically propagate through the graph to all other nodes which are dependent on it. This dynamic updating of the dependency graph is the core of the real-time graphics engine of Maya. A Maya scene is a system of interconnected nodes that are packets of data. The data within a node tells Maya what exists in a scene. Maya contains special node types (e.g., directed acyclic graph nodes) for certain things. Generally, when working on objects in Maya's viewport, those objects, such as cubes, spheres, and planes of surface geometry, are DAG nodes. A DAG node is model of two types of nodes, transform and shape nodes. A shape nodes describes what an object is and a transform node describes where it is. Thus it will be appreciated that a model includes all of the structures and their locations needed to represent the intended object, and those structures can be, for example, nodes within a Maya dependency graph.

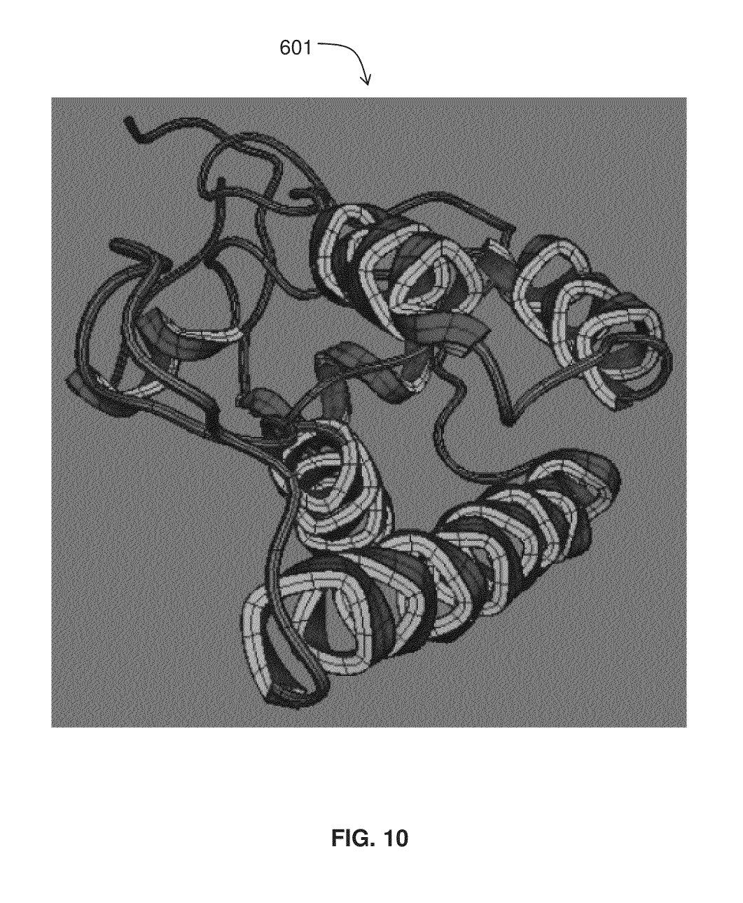

FIG. 10 shows a protein model 601 according to certain embodiments. If created in Maya or Molecular Maya, each polygon or non-uniform rotation b-spline (NURBS) curve of model 601 may be included as a node in the dependency graph. A complex geometry such as model 601 can be obtained by building within Maya or by import. For example, as discussed above, PDB files can be imported directly into Molecular Maya or by exporting VMRL from a molecular viewer. Additionally, complex geometries can be built within Maya using tools for 3D modeling.

Generally, a 3D model includes the geometry provided by surface. Maya supports three surface types: polygons, NURBS, and subdivisions. A polygon geometry includes a surface made up of polygon faces with shared edges and vertices. Polygonal surfaces can be split, removed, extruded, and smoothed. One of skill in the art of 3D modeling will recognize the great breadth of geometries that can be created with polygon surface. So too with NURBS geometries, which basically comprises surfaces created over a network of NURBS curves and converted to triangles when rendered. Subdivision surfaces, or subDs, are a way of adding detail to particular sections of a mesh by subdividing the existing surfaces.

Systems and methods of the invention relate to depicting substantially all of the components and processes associated with a single cell, various cell types, methods for studying cells and relevant model organisms from which cells are isolated and studied. Thus it will be appreciated that some materials are unambiguously within and of the cell—such as the genomic nucleic acid of that cell. However, the comprehensive cellular model may also include extracellular signaling molecules, parasitic and endosymbiotic intracellular guests, viruses that affect the cell, transient materials such as chemicals that freely diffuse across the membrane, and even neighboring cells. Individual components are represented using rigged models. To illustrate rigging, a low resolution approximated model of a viral protein is used due to its simplicity and ease of visualization in the accompanying figures. One of skill in the art will appreciate that the disclosed rigging techniques (and variations thereof) may be applied to substantially all cellular components.

FIG. 11 depicts a model 701 representing a low resolution approximated model of a reovirus sigmal protein. Reovirus attaches to cellular receptors with the sigmal protein, a fiber-like molecule protruding from the 12 vertices of the icosahedral virion. The receptor-binding fragment of sigmal includes an elongated trimer with two domains: a compact head with a beta-barrel fold and a fibrous tail containing a triple beta-spiral. See Chappell, et al., 2002, Crystal structure of reovirus attachment protein sigmal reveals evolutionary relationship to adenovirus fiber, EMBO J 21:1-11. Model 701 can be made by any suitable method such as, for example, drawing a NURBS curve and rotating it around the Y axis. In some embodiments, model 701 is made by importing data from a PDB file, specifically from PDB #1KKE. A PDB file can be imported directly into a program such as molecular Maya or a PDB file can be opened in a viewer (e.g., PyMOL) and exported as VRML which can then be opened by a program such as Maya or molecular Maya to arrive at model 701 as shown in FIG. 11.

Model 701 represents one subunit of the sigmal trimer and the beta-barrel head and fibrous tail are visible. That structure is represented here as a plurality of NURBS curves 705 defining a surface 709. This model 701 provides the geometry file that can be rigged for animation.

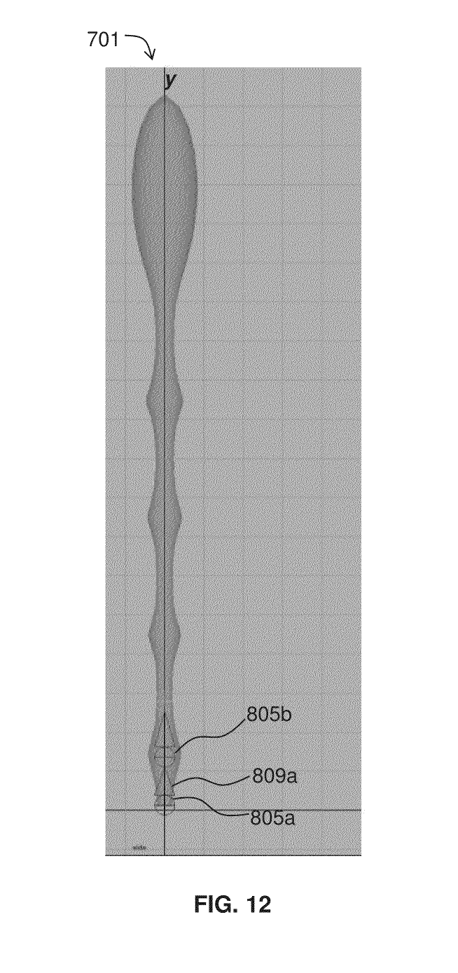

FIG. 12 illustrates one method of rigging model 701 using joints and bones. Rigging includes the creation of organized systems of deformers, expressions, and controls applied to an object so that it can be animated well. A rig will allow an animator to create an animation without himself doing the rigging. That is, rigging is uncoupled from animation or simulation, allowing different tasks to be performed by specialists. As one of skill in the art will recognize, rigging is a continuously evolving practice. Typically, rigging with joints and bones will include starting with a geometry such as model 701, building a skeleton, creating the rig and weighting the geometry. Rigging may also occur using a particle system which can subsequently be used for simulations that depict dynamic motion.

The skeleton is built by adding joints 805 to model 701. Rigging can include using Maya's Joint Tool from the Animation menu to create a skeleton when, for example, beginning work on a geometric structure. For example, if protein is modeled as a mesh, and a scientist wishes to illustrate conformational changes upon binding, the Joint Tool can be used to introduce joints into the mesh, which will be connected by bones (here, bones, joints, and skin refer to the control tools known in the animation arts). Joints are oriented in that their axis (e.g., defining the pivot) is oriented appropriately. Typically, orienting is done before the geometry is bound to the skeleton. In Maya, a joint will be represented by a wireframe sphere. Joints are connected by bones 809, which are represented by wireframe pyramids with the point pointing towards the child when joints 805 are parented together. Generally, a bone 809 will extend between a parent and a child joint 805. A skeleton can be assembled to correspond substantially to a skeleton as known in zoology, however a skeleton more generally represents a structure for animation. In fact, a strength of the animation methods described herein is that the skeleton need not match the natural skeleton. A skeleton may be bound to a skin so that, when bones and joints of a skeleton move (e.g., according to inputs and a rig), the skin presents a visible surface that deforms (e.g., according to how it is bound to the skeleton). As seen in FIG. 12, first joint 805a is created at the end of the fibrous tail of the monomer. When second joint 805b is created, bone 809a is created extending from first joint 805a to second joint 805b. This process is continued for all of model 701.

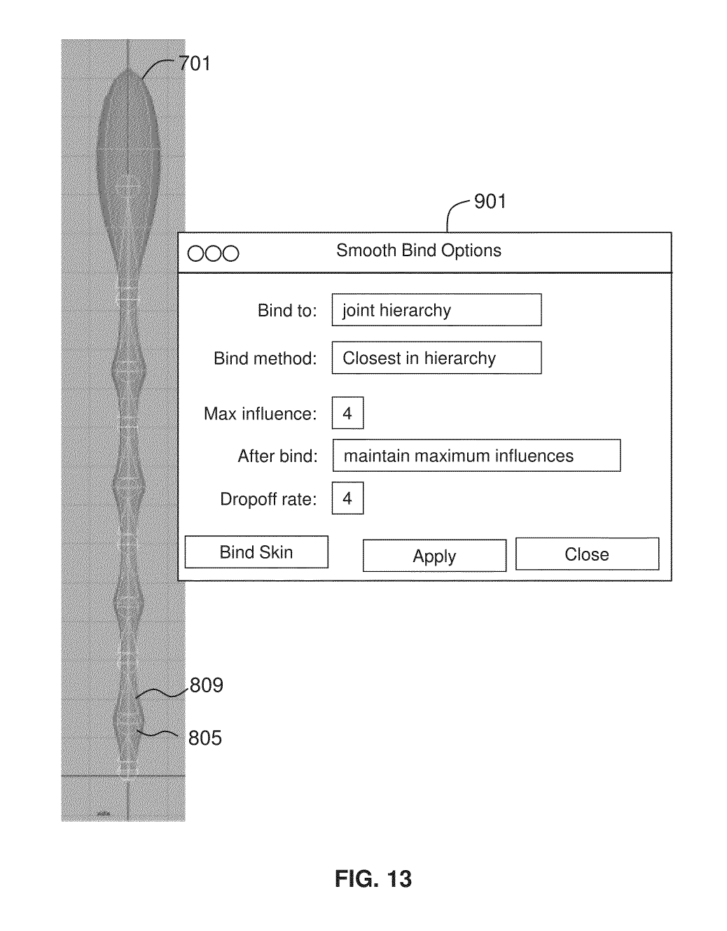

FIG. 13 shows model 701 with a set of joints 805 connected by bones 809 and a dialog box 901 for binding model 701. FIG. 13 illustrates skinning the geometry of model 701. Skinning geometry is the process in which geometry is bound to joints so that, as the joints are rotated or translated, the geometry is deformed. The terms skinning and binding are generally interchangeable. Any type of binding by may be used such as, for example, smooth binding, interactive skin binding, and rigid binding. When geometry is smooth bound, each vertex of the geometry receives a weighted influence from the joints 805. Interactive weighting allows the rigger to set weights by entering them. Typically, the skeleton is bound to the geometry with the skeleton in the bind pose.

Once geometry has been skinned to a skeleton of joints, a system of controls is created to make animating the joints as simple as possible. Controls can be created from locators or curves or any other node that can be selected in the viewport. Other types of deformers may be used besides joint deformers and may include influence objects, lattice deformers, Maya Muscle, and other tools. Using bones and joints created during rigging, parts of a model can be moved with scientific accuracy.

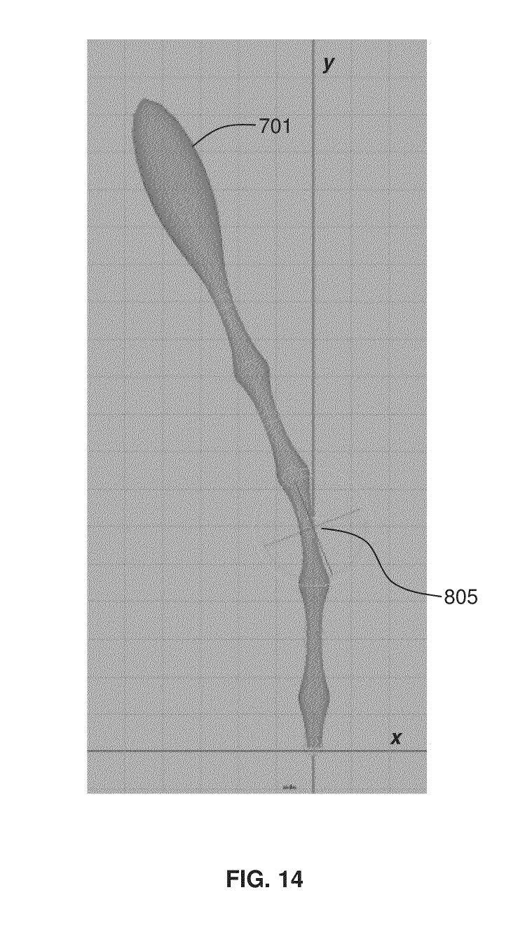

FIG. 14 shows a motion of a model 701 based on the applied rigging. The sigmal monomer has bent around joint 805. Rotation around joints can be controlled by kinematic concepts, as provided for within animation environments such as Maya and molecular Maya.

Such animation environments provide for controls such as forward kinematic and inverse kinematic controls of systems of joints. Forward kinematics refers to having each joint in a chain inherit the motion of its parent joint, while inverse kinematics (IK) refers to causing joints to orient themselves based on the location of a goal known as an end effector. For example, an amino acid side chain in the active site of an enzyme may be rigged with inverse kinematics using the substrate as the end effector. A protein subunit that undergoes a tertiary structure re-organization while changing conformations may be modeled using forward kinematics.

In some embodiments, animation involves the use of deformers such as blend shapes. A blend shape deformer allows a depicted structure to morph between two meshes and allows a user to control the blend and the morph. Typically, at least two topologically identical meshes are created, representing the structure in at least two corresponding conformations. A blend shape is created from the meshes and a node network is created that will work with constraints and rig controls to adjust the animated transformation between the two conformations. In Maya, the two meshes are selected and the Blendshape command is run from the Create Deformers menu. A new node is created and one of the meshes can be deleted (now being represented by the Blendshape).

Preferably, a rigged model includes an animation rig that is easy to understand. For example, controls are labeled and easy to select. For any handle, entering 0 in the translation channels for the controls return the rig to the start position. IK handles use world space coordinates so setting translation channels to 0 moves the handle to origin. These and other principles of good rigging will be understood by those of skill in the art. One valuable tool in rigging includes the use of set driven keys. Driven keys link attributes of one object to attributes of another. Setting driven keys can eliminate the need to move each of a plurality of parts independently.

The invention provide techniques that are suited for complex morphs that allow conformational states of proteins to be depicted. Using systems and methods of the invention, one may create animations that are based on actual data for protein dynamics to provide vibrations and degrees of flexibility that reflect the protein's actual range of thermodynamically-permissible motion. The actual structural data is fed into the geometry of the 3D model 203, and dynamic data informs the rig 207. Not only can rigged models provide a scientifically accurate range of motion for proteins and other structures, other benefits can be included such as collision detection or overlap prevention.

For example, systems of the invention may be operable to register and warn against impending self-intersections through the use of self-aware rigging techniques applicable to scientific structures such as biological macromolecules. For structures such as biological molecules, collision detection rigging can include the use of electrostatic forces (e.g., as mapped to the surface of a space-filling model). Application of such collision-detection rigging (i.e., abiding by electrostatic concepts providing that like-charged surfaces repel and unlike-charges attract) provides a set of simulation tools useful to create molecular vistas with semblance to what happens in nature.

In some embodiments, the one or a set of MEL or Python scripts not only create Maya-native geometry directly from the PDB but also automatically create a rig that has some inherent motion constraints applied. The automatic rigging may be applied with different types of molecular representation (ball & stick versus cartoon for example would have very different ‘rules’ applied to constrain motion). A MEL and/or Python script can apply certain rigging to certain structural motifs automatically and by default. For example, the peptide bonds of a polypeptide can be automatically rigged for realistic rotations. The rigged model can be provided for “fine tuning” by a user by hand.

In certain embodiments, information for the rig is obtained from a scientific data source. For example, the conformational dynamics data bank (CDDB) can be accessed to obtain information about possible conformations of a protein. A rig can be created to restrict the range of motion of the protein model to conformations allowed by the conformation data bank information. A MEL and/or Python script can be used to automatically create that rig and apply it to the model based on CDDB data. The CDDB is described in Kim, et al, 2011, Nucl Ac Res 29:D451-5. Suitable databases for protein dynamics may be discussed in Liu & Karimi, 2007, High-throughput modeling and analysis of protein structural dynamics, Brief Bioinform 8(6):432-45.

Additionally, curated models of the invention are suited for employment in modern gaming engines. In many cases, the digital assets (models, textures, rigs) used to develop high-end games are created in packages like Maya. In like fashion, molecular-movie style animations are generated within an environment such as Maya for application within interactive molecular environments for educational purposes. Further, embodiments of the invention can use rigging concepts to depict motion through animation and can even be used to control levels of granularity at which motion can be depicted. For example, at one level, the overall motion of molecular structures within a cell can be shown, while at another level, motions at the atomic level can be depicted.

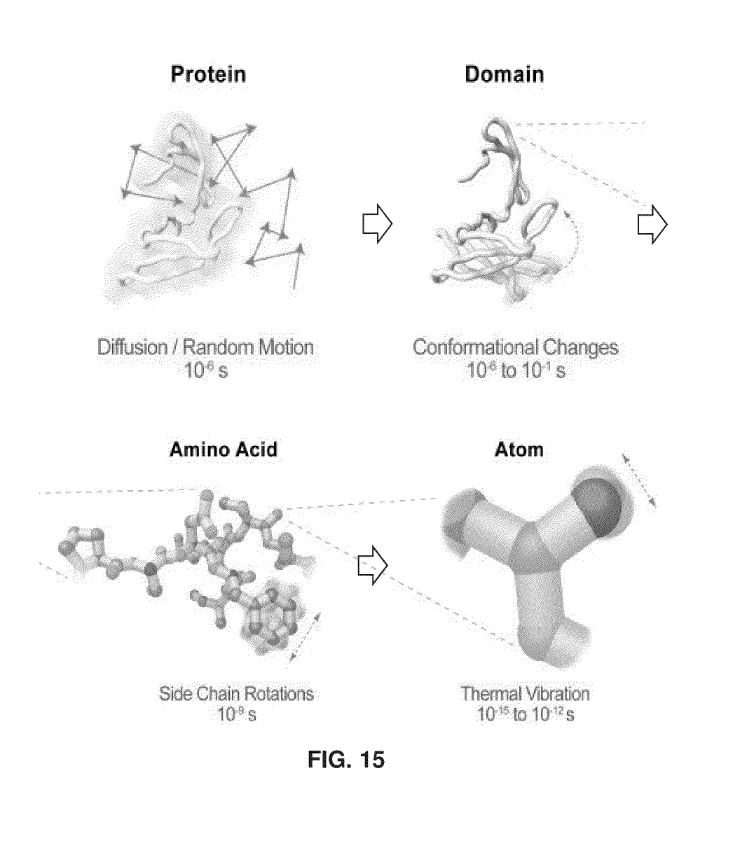

FIG. 15 illustrates protein dynamics at four different levels that can be illustrated using modeling, rigging and simulation concepts discussed herein. As sketched by FIG. 15, the diffusion or random motion of entire proteins can be illustrated. Further, conformational changes associated with domains of proteins can be depicted, for example, within an animation provided by methods of the invention involving the use of rigged models. At a more particular level, the various side chain rotations of individual amino acids can be depicted. Even at the particulate level, the thermal vibrations of individual atoms can be depicted. While discussed herein in terms of using rigged models, it will be appreciated that other tools can be brought to bear in conveying natural phenomenon. For example, process such as diffusion and random motion or Brownian motion can be modeled as stochastic process and such processes can be implemented using computer programming or scripting. For example, MEL scripting or Python programming may be employed.

In certain embodiments, MEL or Python scripts start directly from a PDB coordinate file and generate ribbon or surface representations. In some embodiments, the MEL or Python scripts read from the PDB file, e.g., atom-by-atom. Typically, a set of coordinates will be given to each atom and any bonds indicated in the PDB file will be treated as indicating a connection to another atom. Shading groups are created in the Maya dependency graph. MEL or Python scripts set shading for each atom and create a sphere in the dependency graph. For each bond, a cylinder is created. These models created by MEL or Python scripts may be lighter and cleaner that exports from Chimera or PyMOL since they have been built within Maya using optimized types of geometry, such as NURBS, for example. The geometry file once loaded into Maya appears as a structure in a display. For example, where a PDB file is imported, the protein molecule will be displayed (see FIG. 10 for an example). The molecule in the display can be rotated, translated, and scaled using Maya's native functionality (e.g., hold down ALT+L, M, or R mouse button, respectively, while dragging) for transforming the scene view. A molecule may be displayed using a known format such as a ball and stick model. Sticks represent bonds and balls represent atoms. A molecule may be displayed using a surface model—i.e., showing a surface of the molecule.

In some embodiments, methods of the invention are implemented by programming within an animation environment. Besides MEL, Maya provides an application programming interface, the Maya API. Both MEL and the Maya API support construction of complex geometric objects, creation of new tools and workflows, and manipulation of object and tool attributes. Those programming mechanisms may be found discussed in Gould, 2003, Complete Maya Programming. An Extensive Guide to MEL and the C++ API, Morgan Kaufmann, 528 pages. Preferably, the API is used for large data sets and complex algorithms. Code accessing the API will be contained within a plug-in. Programming within Maya can be used to automatically import structures such as PDB files as geometries or to automatically rig geometries, as discussed above.

As described above in reference to FIG. 7, once rigged, each model 121 is accessioned 271 to curated model database 109. Access to these rigged, digital models 121 is then provided for use in illustrating scientific concepts.

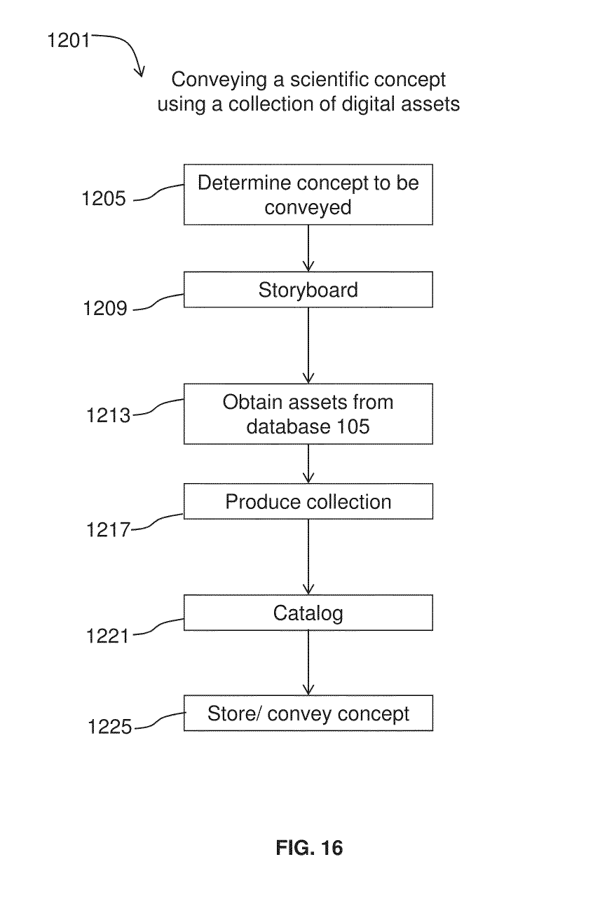

FIG. 16 diagrams a method 1201 of making a visualization digital asset for use in The Visual Cell that includes a plurality of curated models that can be used for conveying a scientific concept. The depiction of a certain cellular concept is determined 1205 to be an important objective. Any suitable cellular concept may be depicted using methods of the invention including, for example, a cellular component or process from a plant, animal, bacteria, archaea, yeast, or any other. Once the cellular component or process is determined 1205, a storyboard is developed 1209 that will determine the curated models to be produced or included. Once the actors or storyboard and concept are settled, curated models 121 are obtained 1213 from database 109 for inclusion in a visualization digital asset that lives in The Visual Cell. The curated model(s) 121 to be included will relate to the cellular component or process to be represented. For example, an Archaea cell will require a lipid monolayer cell membrane and the lipids will have to be modeled appropriately. Curated models 121 may be found to be particularly valuable for illustrated concepts that some students struggle with. For example, a visualization digital asset can be a pathway animation depicting a cascade of events in which at least two depicted biological structures interact only indirectly.

Depicting substantially all of the components of a single cell includes creating digital assets to depict a variety of cellular components and processes. For example, each cellular membrane and compartment, as well as all cellular proteins and nucleic acids, must be depicted. The metabolic and synthetic pathways must be represented as well as the signaling and information pathways. Each pathway and component will be represented by the models and animation choices best suited to those parts.

For example, the mitogen-activated protein (MAP) kinase cascade may be well illustrated using a digital asset that includes an animation. Due to the nature of character rigging, indirect interactions can be understood. For example, MAP kinase kinases (aka MAP2 kinases) are turned on by phosphorylation by upstream kinases (e.g., MAP3 kinases) and themselves phosphorylate MAP kinases. Many of the MAP3Ks, such as c-Raf, MEKK4 or MLK3, themselves require multiple steps for activation. MAP kinases exist that phosphorylate serine or threonine residues near proline on cytosolic proteins and also phosphorylate transcription factors during transcription. Numerous of these interacting proteins exhibit critical activities in separate locations in the cell and never physically meet directly. Thus an animation can illustrate the indirect interactions between, for example, c-Raf and a classical MAP kinase such as ERK1. Since each protein (c-Raf, a MAP2K, ERK1) is included with a structurally accurate model 203 and a dynamically accurate rig 207, an audience can view the indirect influence of c-Raf on transcription via an animation that is scientifically accurate. Additionally, this material can be illustrated through, for example, a web-based interactive decision tree, allowing a freshman student to select input and decide conditions that control a depicted outcome. As discussed, a digital asset can include an animation.

It will be appreciated that, having The Visual Cell, high-quality still images that depict phenomena within the cell with scientific accuracy may be produced. Stills can be composed using models from database 109. For example, if a publisher wishes to illustrate the so-called central dogma of molecular biology within its cellular context to a high-school audience, systems and methods of the invention can be used to produce three stills, one to illustrate each of replication, transcription, and translation at their appropriate locations within the cell. The nucleic acids and proteins can be included based on curated models from the database and the images can be stylized to communicate effectively with the high-school education level (e.g., bases can be presented in a simplified structure and each clearly labeled with one of A, T, C, and G). In contrast, a working researcher may desire a digital visualization digital asset consisting of a still image illustrating an autocatalytic property of a ribonucleic acid for publication in a peer-reviewed journal. Using a curated model from the database, such a still can be composed and—in view of the average post-doctoral education level of the readership—a valence electron cloud for the oxygen of a 2′ hydroxyl group that acts as a nucleophile in phosphodiester cleavage can be illustrated and shaded so that readers visualize the ribozyme reaction mechanism. Thus one can appreciate that systems and methods of the invention can be used to produce The Visual Cell that uses a number of digital visualization digital assets. The Visual Cell, and those digital visualization digital assets, may be tailored to an education level of an audience to effectively convey the phenomena associated with that cellular component or process.

In building and visualizing all of the components and processes of the cell, the invention provides systems and methods for depicting those components in an appealing visual manner Using animation principles, the depiction can be controlled and changed. Once the model cell is created, different users can interact with it to see and learn about different subcomponents. Each component can be added to The Visual Cell by following an animation workflow and the components can be made visual by applying animation principles.

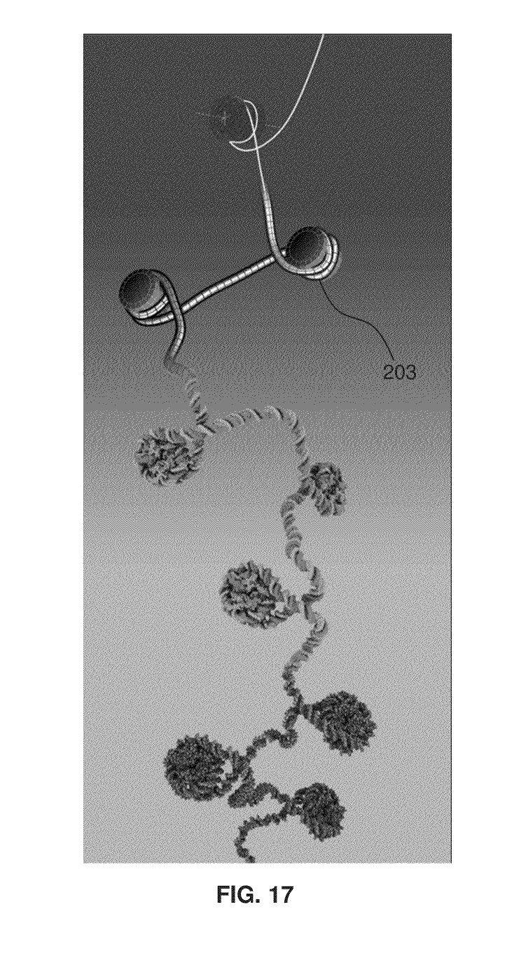

FIG. 17 shows a DNA/chromatin strand in a stylistic manner in which progress through a modeling process is illustrated from top to bottom along the strand. At the top of FIG. 17, the DNA strand is represented by a simple curved line with a histone appearing a simple cylindrical spool shape. Moving down FIG. 17, the modeling of the DNA strand and the histone using polygons or NURBS curves is represented. A user of certain interactive digital assets of the Visual Cell can build up such a model in, for example, without any knowledge of 3D animation software such as Maya or Molecular Maya. Detail is added and, at the bottom of FIG. 17, surface textures and shading and lighting is included in the model so that the packaging of DNA into chromatin is illustrated with a very high level of detail. The level of detail can be selected based on the education level of the audience. For example, advanced chemistry students can be shown the charge distributions on the surfaces of the histones (net positive) and the charge distributions on the surfaces of the DNA (net negative due to the phosphate groups) and this can aid the advance chemistry student to understand that chromatin represents a low energy state in DNA packing. In contrast, for an early elementary student, the level of detail may be kept much lower and it may be most effective to communicate only that DNA is coiled around histones in manner in which a garden hose is stored to aid in storage and retrieval. The bottom-most area of FIG. 17 represents the finished model 203 of DNA and histones.

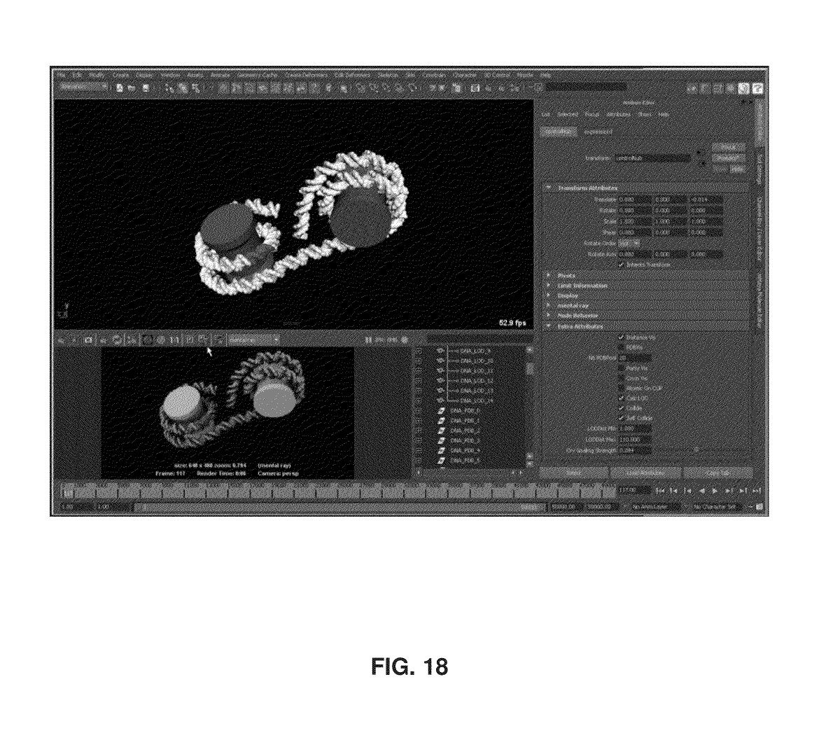

FIG. 18 illustrates use of a product such as Molecular Maya to prepare model 203 showing DNA coiled around histones. Even though the final visual product may be determined to be in a digital asset that will be used by an elementary school audience, the highest possible level of scientific accuracy can be ensured by modeling the actors as rigged 3D structures. Chromatin provides a good example due to the fact that the precise way in which DNA wraps around a histone is a product of the structure and dynamic properties of both DNA and the histone. Rigging techniques can be used to restrict the possible range of motion of the DNA realistically and then to wrap the DNA around the histone, as shown in FIG. 18. That model can then be used to create a visual digital asset that includes a still image.

A visual digital asset including this material can also include multiple layers so that the primary actors (here, DNA and histones) are depicted with scientific accuracy in their natural environment.

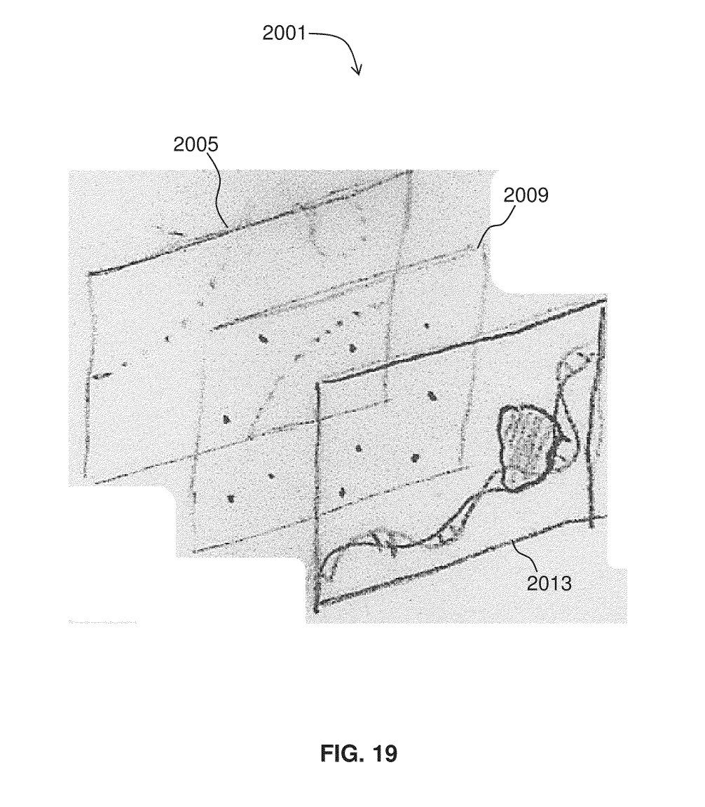

FIG. 19 shows the layers of a molecular visualization as would be represented within a visualization digital asset 2001. In a Visual Cell digital asset that allows users to create their own custom cellular and molecular imagery, a layered structure 2001 for conveying a scientific concept may include at least a back layer 2005, a mid-layer 2009, and a front layer 2013. Any suitable scientific concept can be depicted using such a layered structure 2001. For example, transcription initiation can be illustrated by having back layer 2005 provide a nuclear backdrop. Mid layer 2009 can include environmental proteins as actors (e.g., one or more miscellaneous CCCTC-binding factor). Front layer 2013 will generally include primary actors such as the “hero” protein, here, a transcription factor bound to DNA. Within certain interactive digital assets of The Visual Cell, use of layers provides a tool for allowing a user to craft their own custom visualization. For example, a user may choose to focus on particular component provided within an ingredients list (derived from available curated models within database 109). The computer system can embed this curated model into the front layer and can put directly related components in the mid layer. All other components can go into the back layer. The computer—having granted that the user's focus is on the front layer—can then include each layer at the appropriate level of detail (e.g., back layer can be simplified) to aid the user in understanding their component of interest.

Using different layers can aid in automatically tailoring a visual product to the educational level of an audience. For example, where it is desired to teach simply the wrapping of DNA around histones, the back layer 2005 and mid layer 2009 can be put into soft focus so that the student's attention is given to the front layer 2013. Alternatively, a level of detail in mid layer 2009 can be increased for, for example, a journal publication about binding factors where the audience will typically have a post-doctoral education level. Using at least one rigged model 121, a visual digital asset can be made—such as an animation, interaction, simulation, game, a photo-quality still, or similar material—that can be used to illustrate a scientific concept.

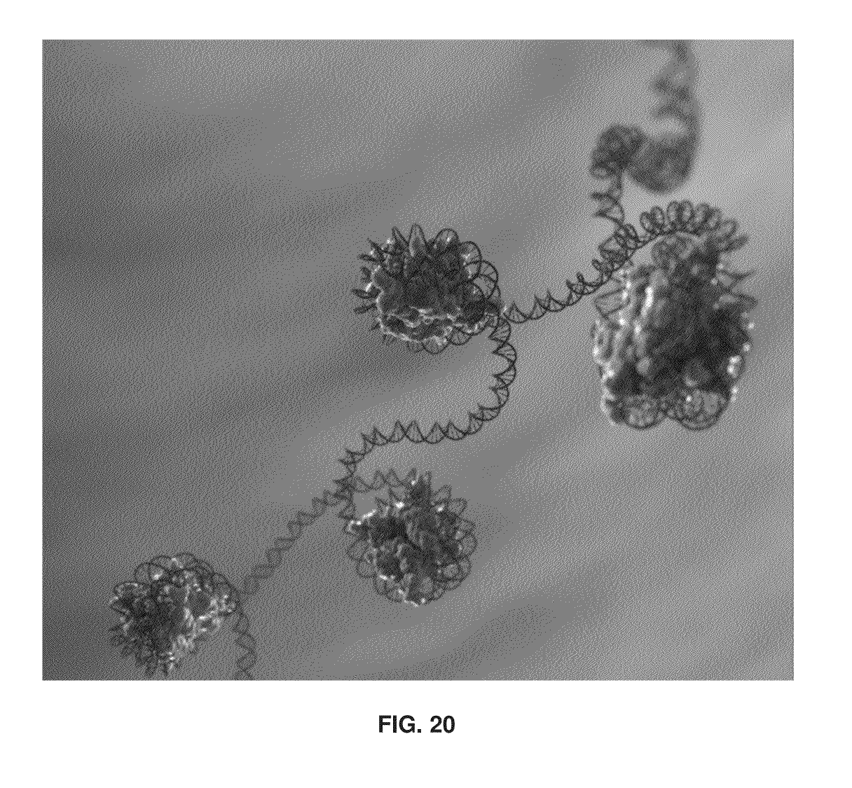

FIG. 20 presents an image that could custom-created by a user within an interactive digital asset of the Visual Cell using layered structure 2001, i.e., the final product of the methods illustrated by FIGS. 18-20. Since layers are used and since material is represented using rigged models, the image in FIG. 20 aids a user in understanding chromatin within the cellular context. The material is depicted with scientific accuracy and is tailored to the education level of an audience.

The Visual Cell includes tools for modeling multi-component systems within the cell with efficiency. Tools are useful where components are known to include numerous instance of like or very similar participles. Modeling tools may employ object oriented programming techniques to create, for example, all of the lipids within a lipid membrane. A phospholipid class may be created, and then for each lipid molecule, the class can be instantiated, and the instance can inherit the structure and rigging of the abstract superclass. Depending on the distance to the virtual camera (depicted here using color-coding) the phospholipid instances can be meshed with various levels of geometry detail thereby resulting a lighter, more memory-efficient 3D model.

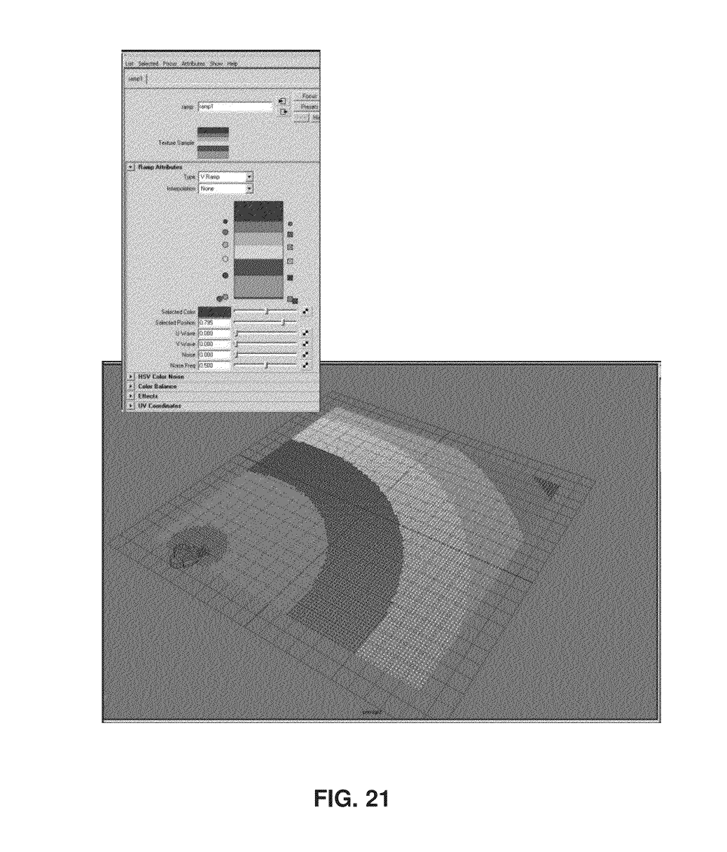

FIG. 21-FIG. 23 illustrate membrane modeling according to embodiments of the invention to create a visualization product. Concepts of the invention include the ability to set or control a level of detail in a visual product. Setting the level of detail can aid in creating a visual product with the highest possible level of scientific accuracy given the available inputs and can also help tailor a visual product to an education level of an audience.

In this example, a bilayer membrane is modeled. Using a modeling environment, a use can establish areas with different levels of detail over an abstracted grid for the membrane.

FIG. 21 shows use of Molecular Maya to establish different regions across a membrane and set progressively varying properties across those regions. Here, a different level of detail is being set (e.g., high level of detail may be set for a region that will be close to a camera).

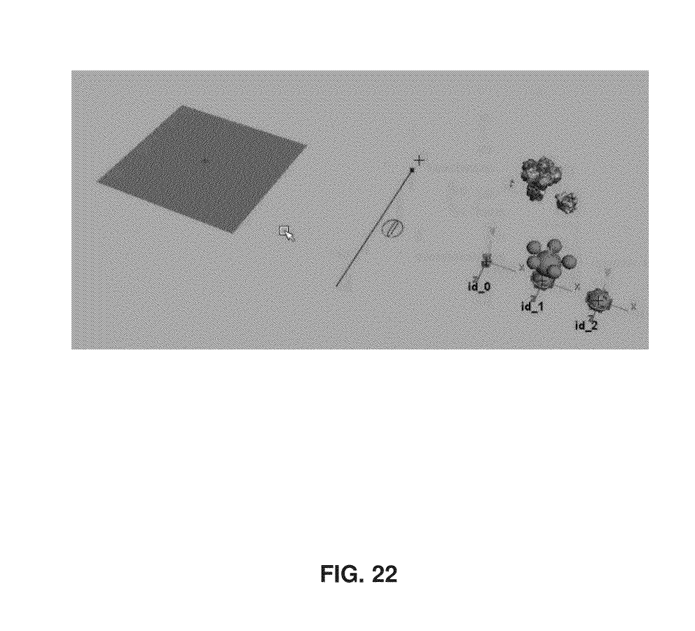

FIG. 22 illustrates bringing individual molecule curated models in to the membrane model. Molecular Maya can then be used to populate the membrane with those molecules. There are different ways to accomplish this. For example, each phospholipid can be created as an instance of a phospholipid structure file that is rigged to allow appropriate rotation around bonds in the lipid tail. Alternatively, the phospholipids can be “drawn” as a set of strokes using, for example, a MEL or Python script. Transmembrane proteins and the membrane can be rigged to allow the proteins to float in the membrane and even displace laterally, if desired. Using the object-oriented approach, each molecule will be instantiated as an instance of the structure. Moreover, each instance can be granted a level of detail based on the region within the membrane where it will be placed (i.e., so that areas of the membrane that are “close to the camera” have a higher level of detail and show some imperfect molecules or show molecules with a greater variety of shapes and motion).

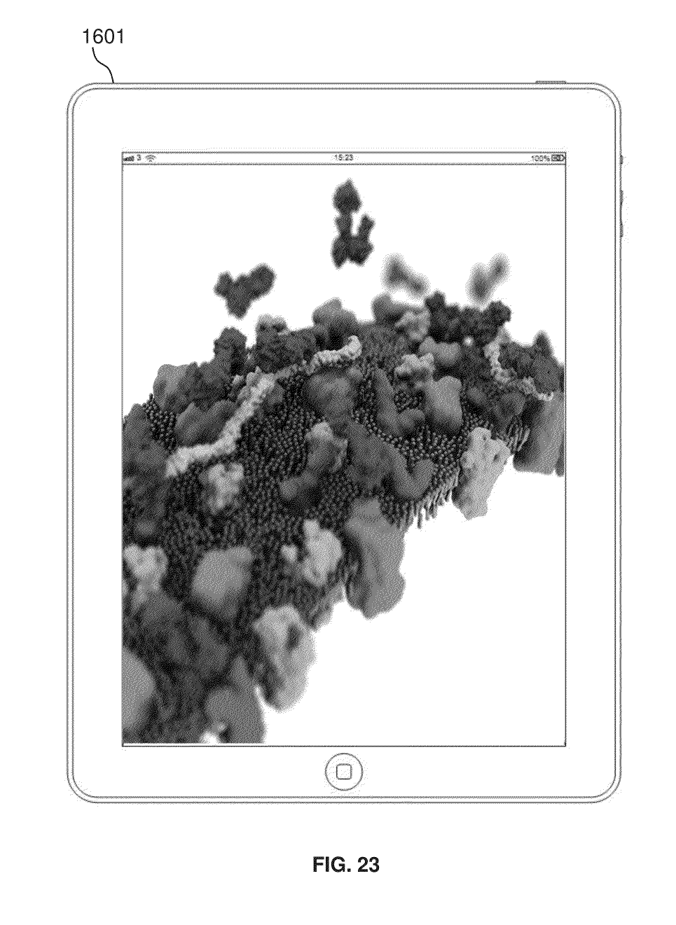

FIG. 23 shows use of an electronic device 1601 to view a cellular membrane. Systems and methods of the invention can be used to render an animation depicting a cellular phenomenon. That is, the 3D model and rigging of a rigged model 121 and any other inputs may be rendered into a bit-mapped based video clip. The rendered animation may be viewed on a screen of 1601.

Additionally, the Visual Cell and its visualization digital assets can be tailored to an education level of an audience. For example, a level of complexity of the digital asset can be set according to an education level of an audience that will view an animation. Additionally or alternatively, parts of the digital asset can be concealed based on the education level.

In some embodiments, systems and methods of the invention are operable to automatically tailor a visualization to an education level of an audience. This can be accomplished by having different qualities of information in either the curated models or the visualization digital assets and using computer program instructions that, within a digital asset or the Visual Cell, selectively use certain of those qualities of information. For example, proteins may include information about surface geometry and also information about charge distribution on the surface. If an education level is within K-12, the charge information may be omitted from an animation, whereas if the education level is graduate or higher, the charge information may be included as a color-coded scheme on the surface of individual proteins.

Tailoring to an education level can include controlling a number of elements to depict in an animation. For example, in an animation depicting transcription initiation, if the audience level is set at grade school, systems of the invention may depict only an RNA polymerase processing a DNA strand. For a graduate education level, the system may include, for example, TATA binding proteins and transcription factors binding and recruiting the polymerase.

In some embodiments, curated models or visualization digital assets may include elements or portions that are tagged with an education level so that systems may selectively exclude those elements or portions for education levels that do not match the tag. For example, in the biochemistry of cellular metabolism, it is thought that in an enzyme-catalyzed reaction, the substrate will fleetingly occupy a highest-energy transition state and that the nature of this transition state precludes its ever being observed according to quantum principles. A model of the substrate may include rigging allowing the substrate to assume the transition state form and may further include rigging that vibrates or blurs the surface geometry at the instant the transition state form is assumed to prevent direct and instantaneous visualization of the transition state form. For an animation in which the education level is, for example, elementary school, any depiction of the transition state may be excluded and the enzyme-catalyzed reaction may be depicted simply as substrate-in, product out. For college level animations, the transition state may be depicted for an instant during the reaction. For an animation intended for a post-doctoral biochemist with an understanding of quantum physics, the uncertain transition state may be depicted.

The Visual Cell can be manipulated to represent different conditions. For example, global cytoplasmic parameters such as temperature, viscosity, salinity, or pH can be set (e.g., some proteins may exhibit different conformations, or some reactions may occur at different speeds, as such parameters vary). To expand, a number of proteins are known to respond to [H+] gradients. If, for example, an ATPase is being modeled in a lipid bi-layer membrane, a user may input a hydrogen ion concentration on either side of the membrane. If the concentration is isomolar the membrane, the ATPase—by virtue of its rigging—will be depicted as static. If there is a hydrogen ion concentration, the ATPase will be depicted as active.

In general, method described herein can be performed using system 401. As discussed above, system 401 includes a processor coupled to a non-transitory memory having stored therein a plurality of models, each model comprising data representing a structure and a rig that defines animation dynamics for the structure such that a range of motion of each model on an electronic display device 129 is predetermined without manipulation from a user.

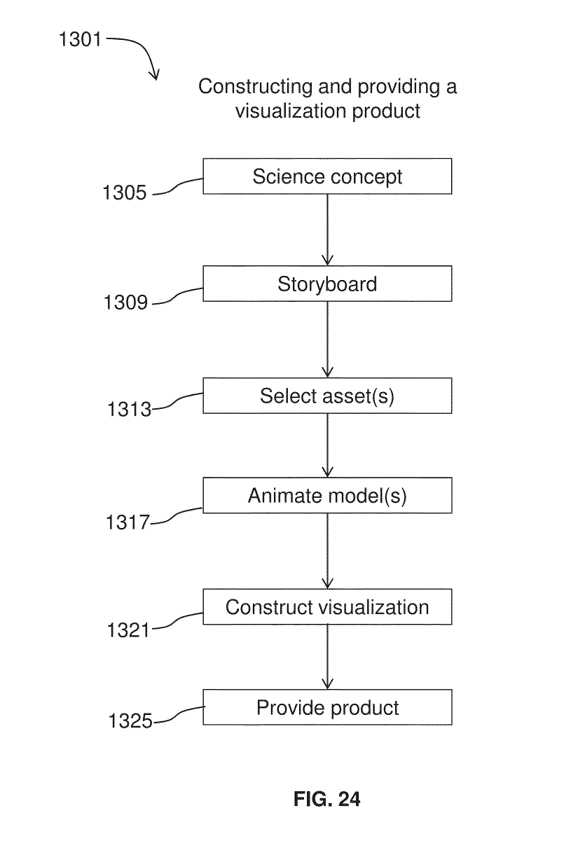

FIG. 24 diagrams a method 1301 for constructing and providing a visualization digital asset that will live within the Visual Cell digital assets database 105. Generally, method 1301 for providing a visualization digital asset includes determining 1305 some science concept or topic to be depicted. A storyboard for the visualization may be developed 1309. Curated models from the curated models database 109 are selected 1313 for inclusion based on the particular phenomenon being depicted. At least one of the curated models will be capable of visually conveying at least a portion of the scientific concept. At least one of the visualization digital assets will include a rigged model 121. Use of a rigged model 121 allows models to be animated 1317. Using a computing device 125, a visualization digital asset is constructed 1321 such that it includes at least one digital asset. This visualization digital asset is then provided 1325 for use (e.g., for viewing by the audience on an electronic display device). Method 1301 may include receiving data related to the education level of the audience.

The visual digital asset may be any digital asset that visually communicates a scientific concept relating to The Visual Cell. For example, the visual digital asset may be an animation depicted on a computer screen or it may include a tangible medium having files stored therein that can be accessed to view an animation. In some embodiments, the visual digital asset is a model of a cellular environment and a software interface that can be loaded onto a user computer device to allow the user to browse in, and interact with, the cellular environment. In some embodiments, the visual digital asset may live inside a digital textbook (e.g., for viewing via a tablet computer or similar device) that guides a user through, for example, a course in cell biology. Providing the visual digital asset may include rendering an animation (e.g., taking the 3D modeling and animation files and outputting a video clip that comprises a series of bitmapped images).

In some embodiments, The Visual Cell is tailored to an education level of an audience. This can include receiving education level information. For example, a user may initiate interaction with The Visual Cell (e.g., using a web interface) and may provide information such as grade level or age. The Visual Cell can then be tailored to the grade level. For example, in some embodiments, tailoring The Visual Cell is done by automatically visually concealing one or more portions of a molecular model or cell environment based on the data related to the education level of the audience.

Constructing and providing The Visual Cell is preferably performed using a system that includes a processor coupled to a non-transitory memory. The system can be used to construct an electronically displayable visualization product that comprises at least one digital asset that visually conveys at least a portion of a scientific concept. The digital asset includes a curated model based on a structure 203 and a rig 207 and is tailored based on an education level of an audience. An end user can access certain interactive digital assets of the Visual Cell system to initiate the custom creation of a visualization.

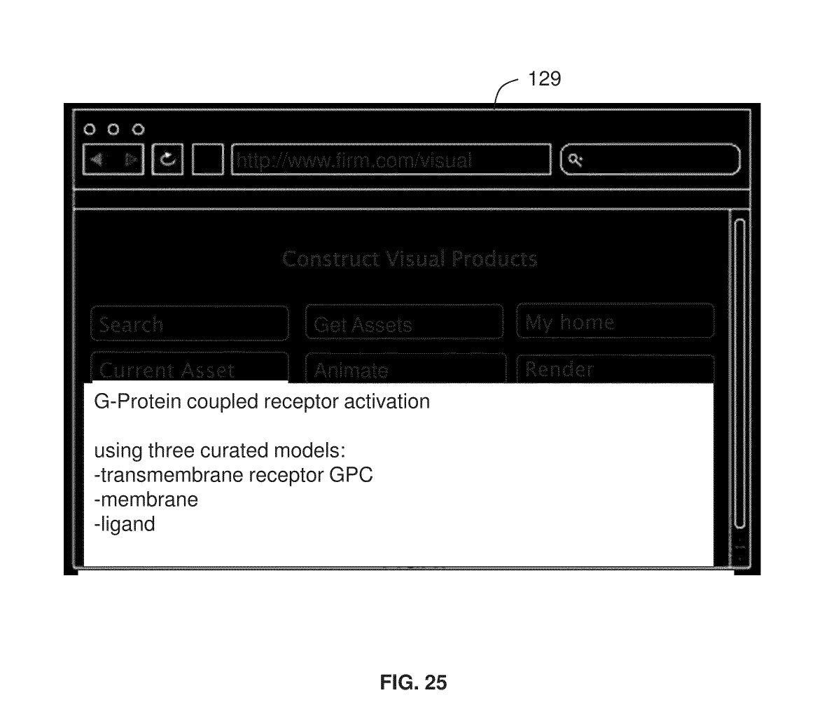

FIG. 25 depicts an interface 129 provided by computing device 125 for using systems of the invention. As shown in FIG. 25, systems and methods of the invention can employ a web front-end or other interface, such as a dedicated application, to allow users to access products described herein. Embodiments of the invention to provide an easy-to-use interface for users to put in suggestions or requests. For example, a user can request their favorite cell type for The Visual Cell. As depicted in FIG. 25, a user may see a web interface to set up a request for a visualization cell that emphasizes certain phenomenon for certain pedagogical objectives.

While discussed above and throughout in terms of a single cell, any suitable scientific system may be illustrated by systems and methods of the invention. For example, embryonic development can be illustrated and conveyed by modeling a developing embryo using one or more rigged model 121. Other systems suited for illustration by methods of the invention include organs, organ systems, populations, gross anatomy, viruses, and other concepts. Using methods of the invention as described herein, any of these scientific concepts and more can be illustrated.

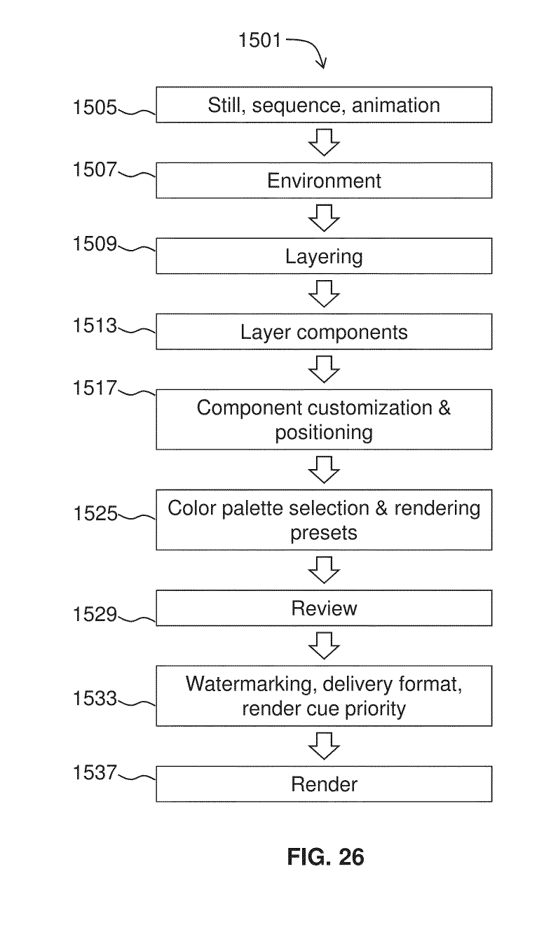

FIG. 26 gives an overview of the web-based decision tree that exists within an advanced visualization digital asset of the Visual Cell which allows users to create custom visualizations using methodology 1501. Method 1501 includes determining 1505 what product to make such as, for example, a still, a sequence, or an animation. The environment is then constructed 1507. Constructing the environment includes layering 1509 (see FIG. 19) and selecting 1513 layer components. Layer component choices depend on the subject matter, the environment, and the layer. If a cellular biology concept is being communicated, options for components to have within various layers of the visual product may include none, nucleus, plasma membrane exterior, plasma membrane interior, mitochondrion, cytoplasm, others, or a combination thereof. Embodiments of the invention include preset curated models and user-driven sets of layer components. The components can be customized and positioned 1517. Options are component-specific such as, for example, animation presets.

Rendering presets and color palettes are selected 1525. Selecting color palettes can include assigning color by component or using an overall Kuler palette, and can also include using an overall image style (ambient occlusion (AO), simulated electron microscope (EM), cartoon-style, combinations). Ambient occlusion is a method to approximate light shining onto a surface. Typically, ambient occlusion is used for realism. Ambient occlusion models rays cast in every direction from a surface. Rays which reach the background increase the brightness of the surface, whereas a ray that hits an object contributes no illumination. As a result, points surrounded by a large amount of geometry are rendered dark, whereas points with little geometry on the visible hemisphere appear light. Programs such as molecular Maya include shaders such as the EM shader to simulate the appearance of electron microscopy.

All of the preceding work can be reviewed 1529, allowing a user to revisit any of the foregoing steps. In some embodiments, the product is watermarked 1533. A delivery format is established. The product may then be rendered 1537. The resulting professional-quality custom visualization can then be embedded by the user into a study portfolio stored within the Visual Cell for further inspection and review by an instructor.

As discussed above and throughout, systems and methods of the invention can be used to create a variety of digital systems (The Visual Cell, organ, organism, solar system, machine, others). Systems and methods of the invention may include additional features and functionality. For example, rigged animations can be used to depict and illustrate such diverse phenomena as polymerization, cell signaling, Brownian motion, lipid bilayer membrane structure, cellular organization, protein folding and conformation, organismal anatomy, embryonic development, bench-top lab experiment protocols, intracellular bio-molecular structure and composition, viral structure and function including capsid packing, the biochemistry of metabolism, phylogenetics, ecological principles, neural function, and other phenomenon.

For example, in some embodiments, models may be provided that illustrate polymerization. Individual monomers may be modeled and rigged so that they will self-assemble in an animation. In certain embodiments, models may be provided that illustrate Brownian motion. Individual particles (e.g., proteins, molecules, other physical particles) may be modeled using stochastic motion.

The audience may be any single person or group of people with any education level, and the invention addresses unmet needs for a variety of different audience types or education levels. The audience may be of a collegiate or post-collegiate level, which may include for example, graduate, medical, post-doctoral or any other level. Content may be provided that is relevant to pre-collegiate, undergraduate, graduate, medical school and post-doctoral. For example, high-school students (e.g., in AP Biology) may be educated through the use of The Visual Cell that is built around a standards-based curriculum in life sciences. The Visual Cell provides support for the teachers as well as the students. The curriculum component of The Visual Cell may include, for example, an assessment integrated into The Visual Cell.

Curricula offered within The Visual Cell make the invention particularly valuable in an education context. For example, pre-med students can learn the effects of drugs on cell systems. For working research scientists, there is a need for the ability to provide scientifically accurate visualizations in which static or animated visuals are derived from actual datasets. Scientists may require a clear provenance of datasets used for a visualization. The Visual Cell may be used by scientists to illustrate and understand competing models for mechanisms. The general public may be well-served by books, articles, TV shows and documentaries that include a scientifically accurate visual cell tailored to the average education level of the general public within a market segment. For example, members of the public may derive great personal enjoyment and satisfaction from downloading and browsing a Visual Cell app for their computer device. A society may be made safer and more prosperous if the public at large has tools for understanding the cellular phenomenon that make up their world. A curriculum will generally include educational materials and preferably includes tools for assessment. In certain embodiments, systems and methods of the invention provide for collaborative learning. For example, content may be tailored to support paired, or groups of, students on projects. Material may be delivered such that tasks or response prompts are directed to members of a pair or group to support collaborative learning objectives.

One benefit of curricula being included with The Visual Cell is that, due to the visual nature of the cell, the curriculum need not be interwoven with prose exposition as required by convention for existing textbooks and journal articles. While the visualization digital assets of The Visual Cell may include some text (e.g., as captions, labels, or navigational instructions), it is preferably substantially visual, which can be taken to mean that The Visual Cell may not include or require expository paragraphs of text for understanding. Including curricula has benefits due to the fact that many people learn in different styles and also that many scientific concepts are conducive to teaching visually. Additionally, a visual mini-curriculum is easier to distribute to audiences with different languages, since chapters of text do not need to be translated.

Assessment materials are embedded throughout The Visual Cell. For example, visualization digital assets may include adaptive assessments embedded within. For example, in illustrating a metabolic reaction, a user may have to drag the appropriate molecule into a scene, e.g., from a palette of candidate molecules. Preferably, the assessment can aid in evaluating a student by, for example, measuring progress through educational objectives.

### INCORPORATION BY REFERENCE

References and citations to other documents, such as patents, patent applications, patent publications, journals, books, papers, web contents, have been made throughout this disclosure. All such documents are hereby incorporated herein by reference in their entirety for all purposes.

### EQUIVALENTS

Various modifications of the invention and many further embodiments thereof, in addition to those shown and described herein, will become apparent to those skilled in the art from the full contents of this document, including references to the scientific and patent literature cited herein. The subject matter herein contains important information, exemplification and guidance that can be adapted to the practice of this invention in its various embodiments and equivalents thereof.

### Examples

### Example 1

### A Mini-Curriculum

What follows is given as an exemplary mini-curriculum that includes assets and collections of assets that may be made using curated models according to embodiments of the invention.

BIOMEMBRANES Visual Mini Curriculum (MEDIA SPEC)

Target audiences: undergraduate General Biology, General Chemistry & Biochemistry (General Biology will also include Advanced Placement Biology)

Approach: develop as a full-fledged mini curriculum and then scale/customize learning path based on course level and individual assessment results.

Curriculum Coverage & Modules:

I. Introduction to membranes
Overview (narrated movie)

II. Lipid structure & properties of lipid aggregates
Lipids, water & understanding the hydrophobic effect
Emergent properties of phospholipids (HTML5 w/ narrated movie+assessments)
Classification of lipids & fats
Lipid structure assessment (‘inspect, orient and label’ 3D interactive assessment)
Evolutionary aspects of membrane structure (narrated movie)
Archaeal membranes (treated separately from evolution above)

III. Biomembranes & their constituents
The fluid mosaic model (narrated movie)
Membrane permeability (narrated movie)
Assessing the fluidity of membranes with cell fusion (HTML5)
Assessing membrane protein diffusion with FRAP
Membrane micro-domains, lipid rafts & signaling
Diversity of biological membranes
Model a membrane (′create your own study figure′ interactive/assessment)
Spanning the membrane (interactive figure)
Using hydrophobicity plots to predict transmembrane domains of proteins
Blood typing game

IV. Transport across membranes
Overview of transport mechanisms
Passive transport in detail/example (movie+assemble sequence interactive)
Active transport in detail/example (movie+assemble sequence interactive)
Co-transport in detail/example (movie+assemble sequence interactive)
Electrochemical gradients (interactive simulation w/ drag-and-drop elements)

V. The endomembrane system & bulk transport
Endomembrane system
Membrane curvature
Endocytosis & exocytosis
Mechanotransduction through membranes
Normal and virus-induced membrane fusion

Additional modules to consider
‘Membranes in the lab’
‘Membranes in the clinic’
‘Do-you-believe-it?’-themed module
‘Hot-off-the-press/bench’-themed module
visual glossary (with etymological roots)

Detail of Visual Mini Curriculum Modules

I. Introduction to Membranes

Overview (Narrated Movie)

Covers the overall role of membranes (the ‘edge of life’), geography of membranes within cells, key molecular actors (lipids, proteins, sugars)—puts membranes in the cellular context and establishes the basic challenge at hand: controlling the passage of substances through them. What comes in, what stays out.

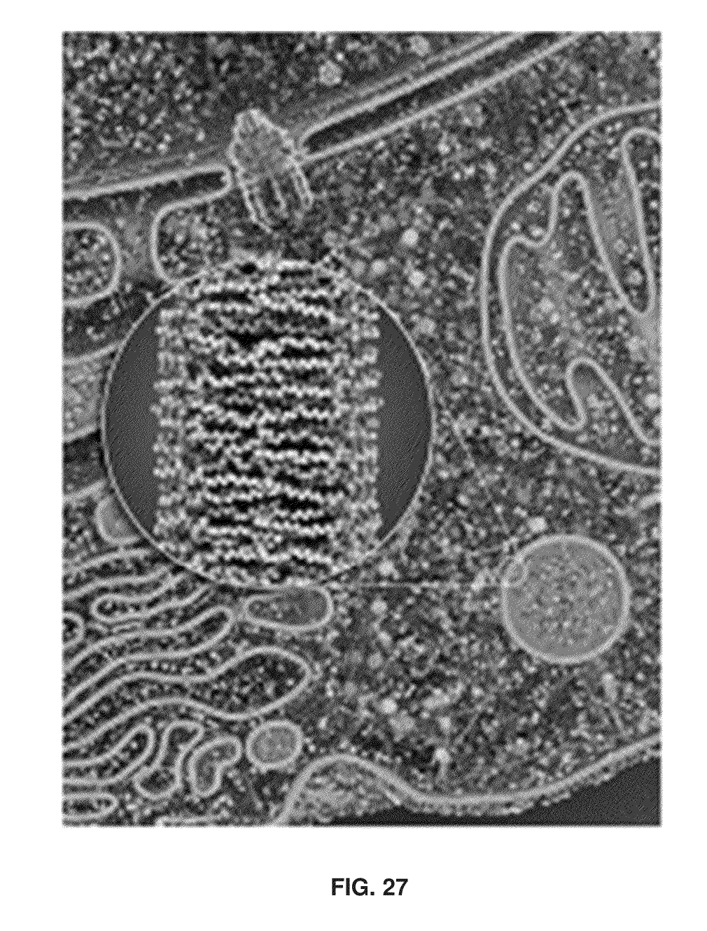

FIG. 27 illustrates a detail of a membrane.

(Curriculum may include a video or a link to a video and may also allow students to post examples from nature, from their lives, analogies, connections—on the topic of controlled passage.)

II. Lipid Structure & Properties of Lipid Aggregates

Lipids, Water & Understanding the Hydrophobic Effect

A module that combines an introductory narrated molecular movie and a visual assessment section that gets students to relate local perturbations in H-bond formation in bulk water by free/exposed aliphatic chains of a phospholipid.

part 1—a short narrated movie that explains how a molecular system always ‘strives’ to reach its lowest energy state (restatement of the 2nd law of thermodynamics). Visualize, as part of a small MD simulation, the H-bonding pattern of water in ice, liquid and gas states. We would show how increasing the amount of thermal energy fed into the system. These visuals will be accompanied by a quantitation of the average number of H-bonds per molecule in the system (4 for ice, 3.6 for water, and ˜2 for ones surrounding a hydrophobic molecule).

part2—a series of visual assessment activities that show students simulations (with accompanying quantitative illustration of H-bond number & corresponding energy changes) and asks them to observe the data and offer explanations. Could include 2 steps/simulations:

1. Visualize lone phospholipid in bulk water start with review of average H-bond numbers per molecule in bulk water (visual+quant); focus on single hero molecule (again, highlight H-bonds only for this one molecule); and show what happens when it diffuses and joins the hydration shell of a dissolved phospholipid (with quant), and then again when it leaves. Spend a few seconds, as an aside, showing H-bonding of water with polar head-group (and the fact that these waters DO maintain a higher # of H-bonds similar to bulk water). End with a highlight of all molecules in the hydration shell w/ average H-bond number for each (versus bulk water).

Visual assessment activity whereby students draw likely average curves (of either energy or H-bond number) for 2 individual molecules (1 bulk & 1 shell) or 2 highlighted populations of molecules (all bulk & all shell)

2. Visualize formation of a mini micelle in bulk water—a narrated movie Visual assessment activity whereby students—having seen the results of the micelle formation simulation—predict/estimate the energy of the entire system between frame 1 and the last frame.

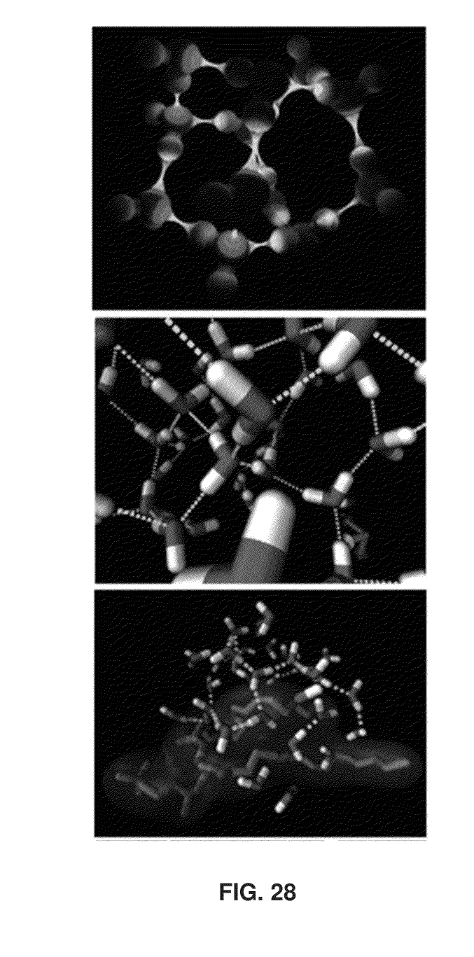

FIG. 28 shows an H-bond network in ice, bulk water and around a fatty chain.

Emergent Properties of Phospholipids (HTML5 w/ Narrated Movie+Assessments)

How lipid structure/composition influences formation of micelles versus bilayers.

Narrated split-screen movie that compares micelle formation using a single-chain phospholipid (PDC, dodecyl-phospho-choline) and bilayer formation using a double-chain phospholipid (POPC, palmitoyl-oleoyl-phosphatidyl-choline). At end of movie, student is challenged with a series of questions based on visual inspection of selected frames or structures previously shown in the simulations (for ex: show snapshots of a stable micelle versus an intermediate aggregate highlighting any remaining hydrophobic areas in both (none in micelle, some in aggregate) and ask student to predict how system might evolve. (answer is that micelle is stable—fully shielded—but aggregate would want to further aggregate/fuse in order to protect/bury its remaining hydrophobic surfaces). Another question will show student 3 new phospholipid structures (optional graphical highlight of their overall conical versus cylindrical shapes and ask student to predict what types of larger assemblies they are most likely to form. (optional 2 radio buttons for each of the three lipid structures: micelle, bilayer).

Classification of Lipids & Fats

Explanation of chemical structures—‘amphiphile’ concept (hydrophilic vs hydrophobic) differences between saturated/unsaturated & associated dynamics/flexibility

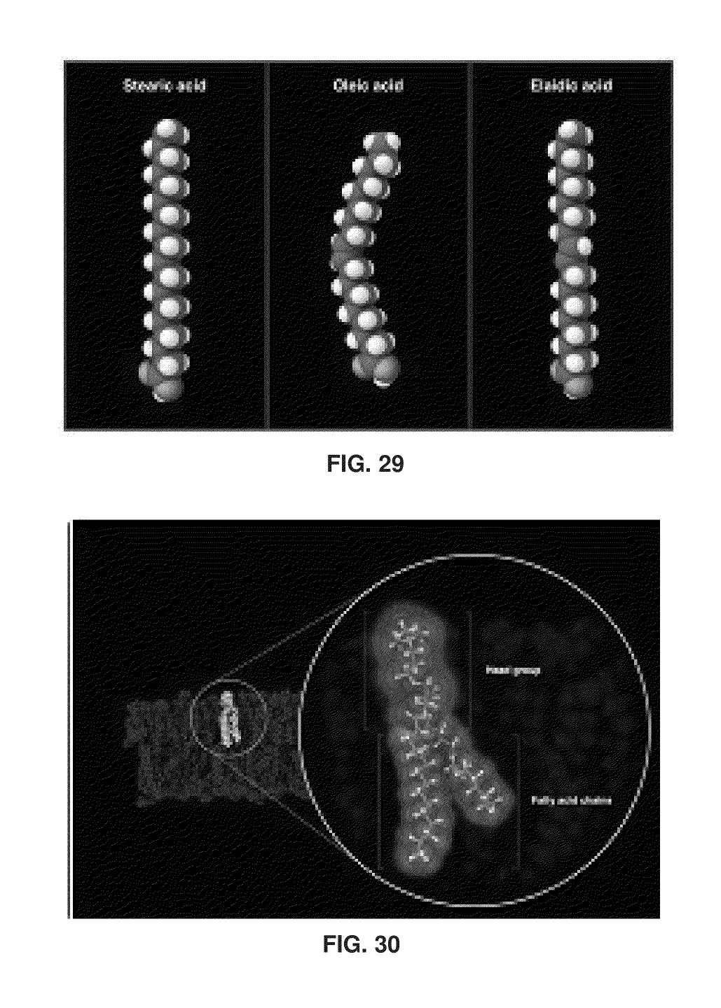

FIG. 29 illustrates chemical structures for stearic acid, oleic acid, and elaidic acid. Other structures include phosphatidylcholine (PC), phosphatidylethanolamine (PE), phosphatidylserine (PS), phosphatidylinositol (PI), cholesterol (Chol), sphingomyelin (SM), others.

FIG. 30 shows a phospholipid in a bilayer.
‘Inspect, orient and label’ 3D molecular interactive assessment module

The student is given a molecular model (in this case various fats, lipid structures—complexity of models presented will depend on level of instruction). Student inspect model interactively in the browser (using Unity) and considers how to optimally orient and then take a snapshot of the model in order to make visible and highlight key structural features. Student is then able to label their snapshot and enter/save it into their online ‘study portfolio’ (this is a way of using 3D interactivity as an assessment activity—as opposed to just ‘explore the structure’ which feels too unguided). (The concept of an e-portfolio is gaining increasing acceptance in higher ed. Students assemble evidence of their mastery in a variety of forms—written, videos, images, interactives.)

Evolutionary Aspects of Membrane Structure

different lipid compositions (saturated/unsaturated/other) depending on environmental temperature composition=evolutionary adaptation

structure of ‘normal’ bilayer with Archaeal monolayer with increased temperature.

evolutionary connections throughout. Might even see these nuggets as a separate “widget”, mostly so that professors could see them all or arrange all into a special cross-cutting mini-curriculum. Help students make cross-concept connections.)

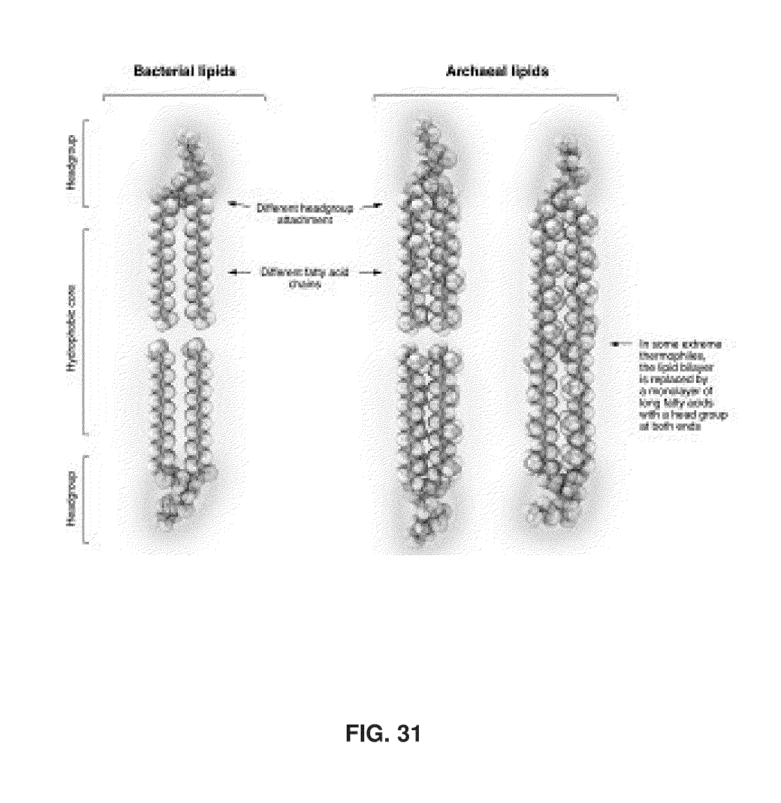

FIG. 31 shows 1 phospholipid in a leaflet on the left versus 1 Archaeal lipid on the right.

(in adapting this existing simulation/visualization, make sure to temporarily highlight 1 phospholipid in a leaflet on the left versus 1 Archaeal lipid on the right—currently hard to tell the structural difference)

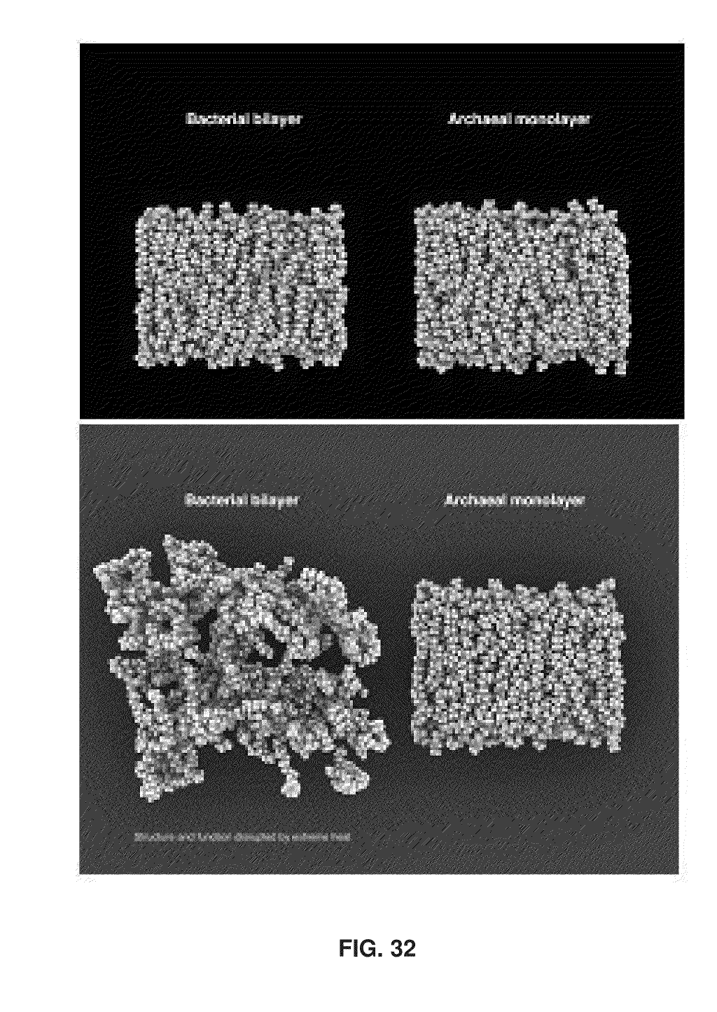

FIG. 32 illustrates a structural difference.

III. Biomembranes & their Constituents

The Fluid Mosaic Model

Membranes are fluid mosaics of lipids and proteins—almost every protein in the membrane is laterally ‘sensing’ another protein that is only a few lipid radii away. Extra-membranous domains of peripheral and integral proteins lead to significant crowding of membrane surfaces, as well as the contribution of carbohydrates (glycosylation).

Bacterial lipids Archaeal lipids Different headgroup—attachment—Different fatty acid—\ddot{γ} chains In some extreme thermophiles, the lipid bilayer is replaced by a monolayer of long fatty acids with a head group at both ends Bacterial bilayer

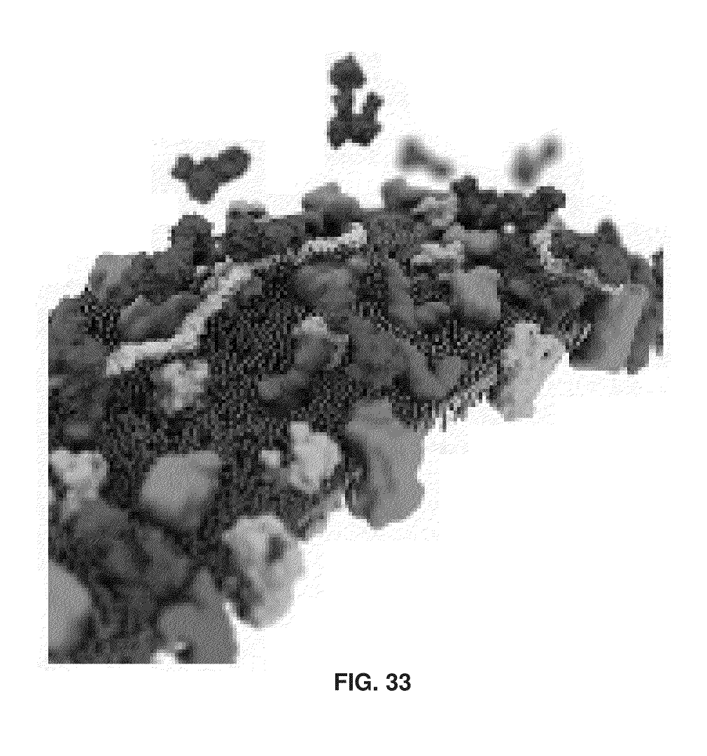

FIG. 33 illustrates an Archaeal monolayer.

Membrane Permeability

Narrated animation shows difference in intrinsic (i.e. lipid only) membrane permeability to water, ions, alcohol, small molecules, drugs and others.

(optional activity where students are challenged to drag different molecules or ions across a membrane? Water, Na, K, glucose. What goes and what doesn't? Why?)

Assessing the Fluidity of Membranes with Cell Fusion

The intention of this interactive-assessment module is for students to ‘rediscover’ these early observations and draw their own conclusions about membrane fluidity . . . several outcomes and experimental variables can be used:

explain goal of 1970 Frye & Edidin experiment & general methods (visualize basic cell fusion, staining and time course steps). Frye and Edidin, 1970, The rapid intermixing of cell surface antigens after formation of mouse-human heterokaryons, Journal of Cell Science 7:319-335.

provide data table (simplified/averaged Frye & Edidin data)—have students plot the data and suggest explanations for these findings. (optional question for more advanced levels—ask students what these experiments tell us about the fluidity of proteins on the INSIDE of the cell's plasma membrane?)

researchers offered at least 2 explanations for their results: 1) surface antigens diffuse freely in the plasma membrane and 2) rapid turnover of antigens (i.e. existing ones are recycled/degraded quickly and new ones are embedded in the membrane).

Ask students to suggest experiments to differentiate between these explanations (or offer a small selection of follow-up experiments and ask students to pick which one they feel is best suited to tell these mechanisms apart).

Reveal that the researchers repeated their experiments in the presence of a series of metabolic, protein and carbohydrate synthesis inhibitors, as well as at different temperatures

We now know that there IS a lot of turnover in membrane constituents and that the cytoskeleton plays a key role in the shuffling of membranes. Ask students to suggest other experiments to address whether the cytoskeleton was involved in the events observed by Frye & Edidin (i.e., could use cytochalasin B or colchicine)

Based on what students have learned about the influence of lipid constituents on membrane fluidity (saturated and unsaturated lipids and cholesterol), ask them to hypothesize what might happen to the Frye & Edidin time course in membranes with different lipid compositions.

Assessing membrane protein diffusion with Fluorescence Recovery After Photobleaching (FRAP)—Similar to concept of Peters 1974 experiments (except that they had to treat cell surfaces with fluorescein isothiocyanate—didn't have GFP-fusions!) Peters, et al., 1974, A microfluorimetric study of translational diffusion in erythrocyte membranes, Biochimica et Biophyisca Acta—Biomembranes 367(3):282-294.

Explain how method works.

Initially could have students control the bleaching beam and simply observe fluorescence recovery under various circumstances (like temperature or other variables).

A different experimental set-up is now provided where the student still controls the beam but we have 3-color fluorescence emitting from the cell—each color is a GFP fusion with a different membrane protein (but we don't reveal the identity of these proteins). The patterns overlap but are geographically distinct (hence usefulness now of having the student control the bleaching area; assume 3 colors can be visualized all at once for interactive).

Student is asked to sample different areas of the cell in order to target regions with different color staining patterns.

They observe different rates of recovery depending on the fluorescence color and are asked to hypothesize for mechanisms to explain this.

Based on cellular location and rate of diffusion, ask students to venture as to the possible identity (even just general molecular family) of these signals. Then reveal what they are along with a short explanation of that membrane protein's function (will be an opportunity to give examples of a freely-diffusing membrane protein, one associated with the cytoskeleton and perhaps one associated with the extracellular matrix).

Membrane Micro-Domains, Lipid Rafts & Signaling

A module that combines real images with an idealized top-view diagram of a membrane where student can observe or draw diffusion trajectories (in other words can either be shown data and asked to make observations/predictions or told about a mechanism and asked to draw expected trajectories and their speeds). Refer to real data/movie from Ron Vale lab using lck-GFP/CD2 movies. (incidentally, this is an opportunity to refer back to an enigmatic observation in the Frye & Edidin experiments that showed partial mosaics in fused cells at intermediate time points (i.e. human antigens appeared to diffuse more quickly than mouse ones in the heterokaryons—although they eventually completely overlapped). This is due to the fact that the anti-human stain was using sera raised against whole human cells, whereas antibody used to stain the mouse cells/antigens was specific to the H2 antigen (i.e. MHC) which is now known to exist in clusters and probably has reduced mobility.

Diversity of Biological Membranes

A visual exploration of the diversity of membranes within a cell, across cell types and across organisms:
within a cell
plasma
ER/Golgi
mitochondrial (inner/outer)
nuclear
across cell types within an organism
erythrocyte membrane
axonal/post-synaptic
adherens/tight junctions
other distinctive ones?
across organisms
eukaryotic
prokaryotic (gram+/−)
plant

‘Create Your Own Study Figure’ Interactive

This unique module leverages a database of curated molecular models
The module randomly assigns (optionally adaptively based on past performance in certain areas related to membrane diversity) to the student a type of membrane to model (e.g., an animal membrane, a plant cell membrane, make a bacterial membrane, an erythrocyte membrane from someone who is in the A blood group, etc. . . . )
Student is given a menu of molecular actors (lipids, proteins, carbohydrates) and can chose to include or leave out each (where relevant, may even be able to dial in quantities)
Student submits their suggested recipe for their custom membrane
Student receives (onscreen):
A professional-quality 3D rendering of their membrane patch
An interactive of the 3D model in Unity (pre-rendering) (or both)

This allows for interaction, further customization perhaps and custom orientation. Note that each image will be unique to each student (even if 2 students dial in exactly the same molecular actors and relative quantities—this is because the membrane patch is simulated before being rendered).
This image becomes the basis for either a live flipped classroom activity or social media-based virtual/forum-based activity—whereby students, guided by the instructor, critique each other's imagery for veracity/accuracy.
With feedback in hand, the student returns to their saved membrane recipe online, modifies it and resubmits it. Using this final image, the system brings up all relevant labels in the window and the student goes about labeling (via drag-and-drop online) their study figure, which can then become part of their digital study ‘portfolio.’

Spanning the Membrane

This interactive figure is a select visual catalog of structures/folds that nature has evolved to span the lipid bilayer. Default state of figure shows a single horizontal cross-section of a membrane with many proteins embedded/lined-up next to one another—the graphic style highlights the secondary structure of the transmembrane portion of each and showcases the structural diversity of folds used to span the membrane. By mousing-over each structure, student reveals (in close-up if necessary) the key hydrophobic side chains that enable these TM domains.

Using Hydrophobicity Plots to Predict Transmembrane Domains of Proteins

Students can interactively mouse over a primary structure and hydrophobicity plot in order to view the corresponding residues in the folded, membrane embedded proteins.

Blood Typing Game (with a Focus on Relevance to Membranes!)

A patient of known blood group enters the ER, and in need of a blood transfusion—ER has just received blood but the label has fallen off the bag and blood is now of unknown blood group. The goal of the game is to test and identify the blood group for the blood sample in order to start the transfusion and save the patient.
Students being by mixing serum (i.e. antibodies) of the individual needing a transfusion with unknown blood/RBCs
We visualize erythrocyte/RBC aggregation—little short animations show antibodies either ‘flying by’ the RBCs or binding and cross-linking them, leading to aggregation. If aggregates form, then you know right away the blood type. If they don't aggregate in round 1, then you could just go ahead and give that blood to that patient, but you would like to fully identify it in case another patient come in requiring blood. This indicates a need for an additional test.
Student carries out an antibody-based test against the potential remaining antigen to differentiate that antigen (A or B) from O
As a result of figuring it out, the student visualizes the surface of the RBCs in the donated blood—i.e. antigens A, B or absence of either (and of course, patient gets transfusion and is saved).

IV. Transport Across Membranes

Movies explaining the structure/function of proteins involved in key types of transport:
passive transport (down gradient, no energy)—include facilitated & gated transport
active transport (up gradient, needs energy input)
co-transport (down gradient of one, allows up gradient of other)

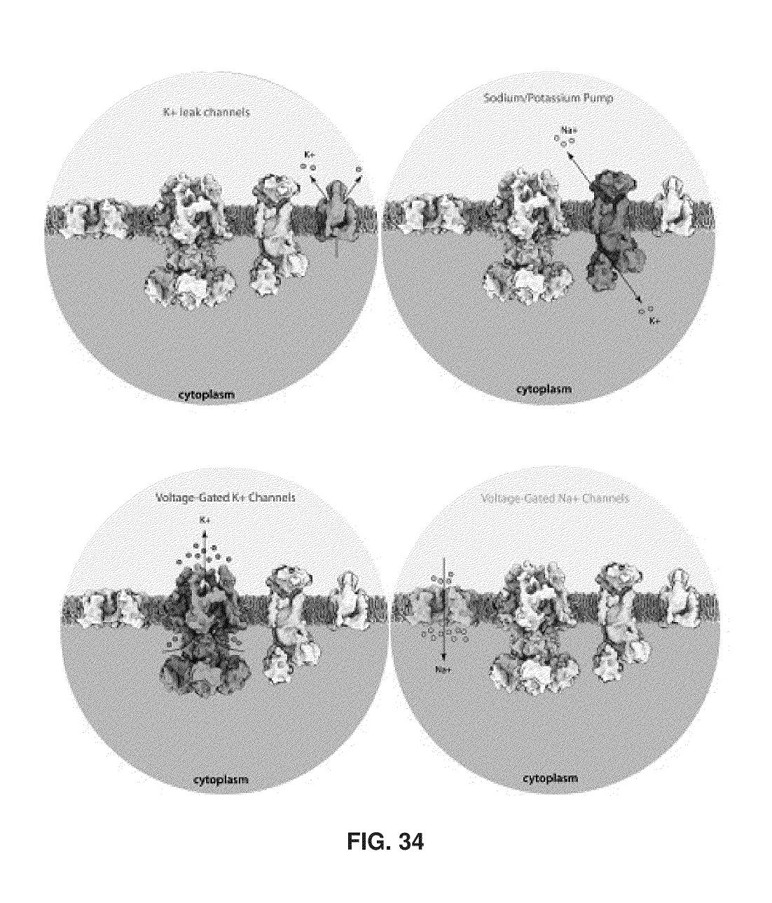

FIG. 34 illustrates types of transport

Also show structure/function of:

aquaporin

connexin (connexons/gap junctions)

pore-forming toxins: hemolysin A (beta sheet-based), cytolysin (alpha-helical)

Interactive Module to Explore how Cells Create and Maintain Electrical and Chemical (Electrochemical) Gradients and Harness their Potential Energy.

V. The Endomembrane System & Bulk Transport

Endomembrane System Overview of Membrane-Enclosed Organelles

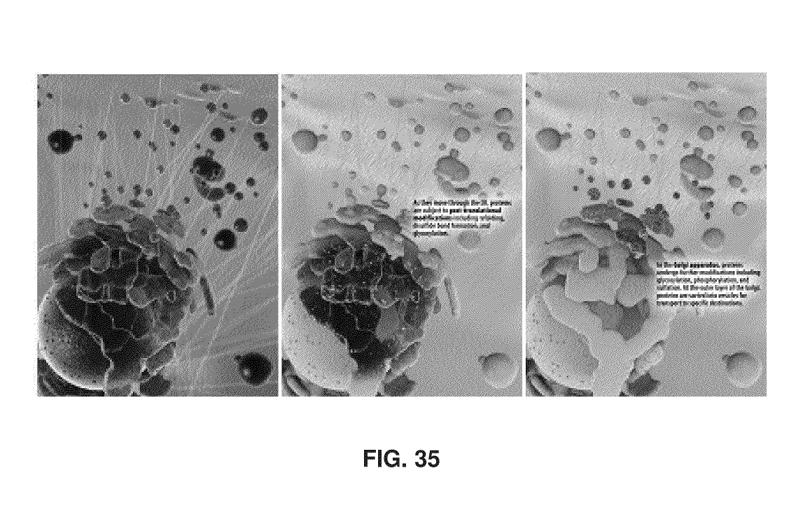

FIG. 35 shows an overview of membrane-enclosed organelles.

Membrane Curvature

Examples of how certain proteins (i.e. BAR-domains and others) preferentially bind curved membranes and also stabilize them (relevance to the function and maintenance of the endomembrane system).

Endocytosis & Exocytosis

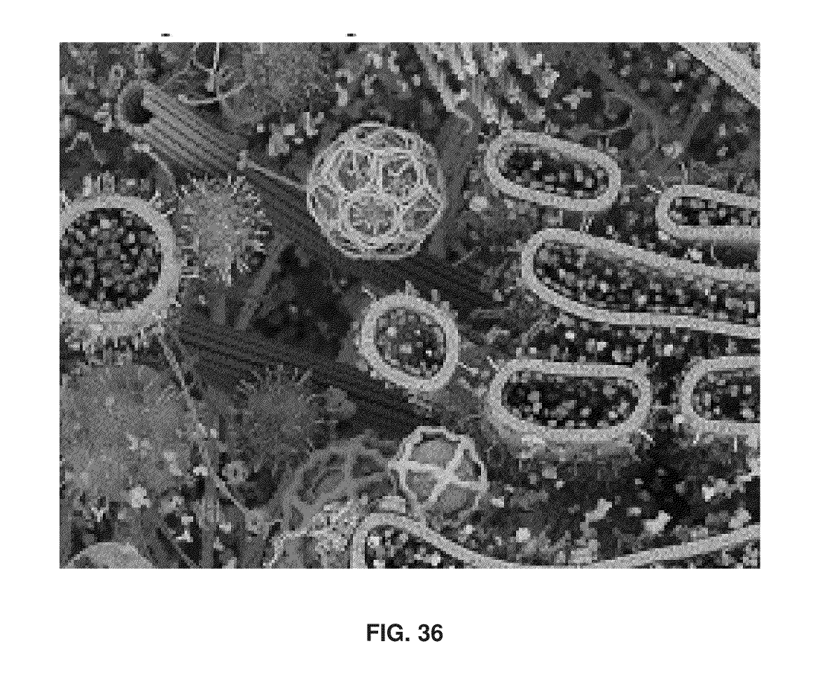

FIG. 36 shows organelles and molecular actors relevant to endomembrane transport system (including endo-, exo-cytosis, and vesicle transport)

Mechanotransduction Through Membranes

Examples of how proteins can influence membrane thickness and how membrane composition and tension can influence protein function

Virus-Induced Membrane Fusion

Viral strategies and associated molecular machinery that drive this energetically-unfavorable event

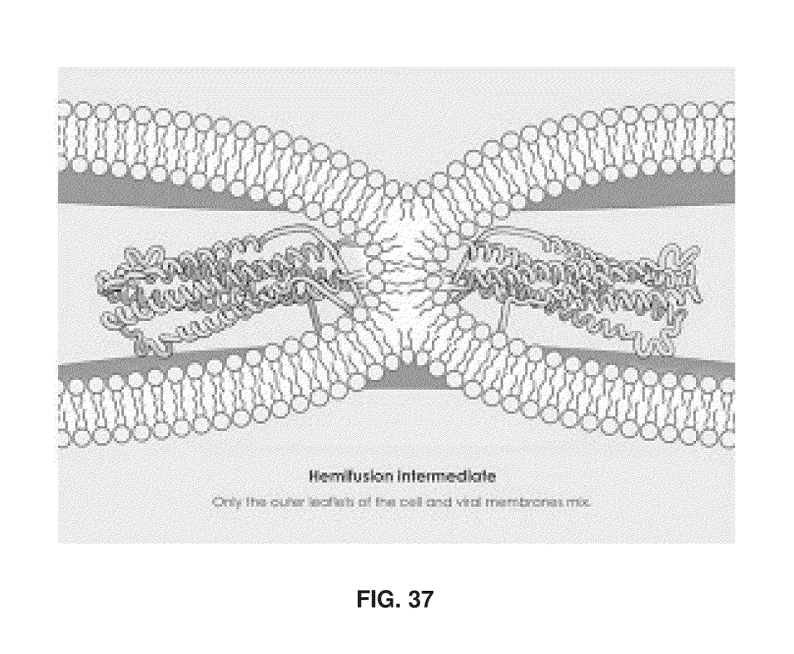

FIG. 37 shows a hemi-fusion intermediate.

Additional modules that may be optionally include in BIOMEMBRANES visual mini curriculum

‘Membranes in the Lab’

Explores intersection of scientific principles covered above and practical knowledge about manipulating membranes in an experimental/lab setting. For example how to use detergents to solubilize or fractionate membranes.

‘Membranes in the Clinic’

Use an example like the Multi-Drug Resistance (MDR) channel to explain the clinical relevance of proteins that can expel small molecule drugs from cells

‘Do-You-Believe-it?’-Themed Module that Offers Data Supporting an Alternate (or Slightly Modified) View of a Mechanism

‘Hot-Off-the-Press/Bench’-Themed Module

Highlights very recent data/finding in the field—gives students a feel for how area is still actively being studied and what are the key remaining unknowns.

Visual Glossary (with Etymological Roots)

(reference visualization data & methods embedded within each of these widgets)

What is claimed is:

1. A method for viewing a component or process of a single cell, the method comprising:
accessing via an electronic display device a system for visualizing substantially all components and processes of a single cell, the system comprising a processor coupled to a non-transitory memory having stored therein:
a plurality of interconnected digital assets that in the aggregate represent substantially all components and processes of a single cell, wherein each digital asset comprises at least one curated model that visually conveys at least a portion of a component or process within the cell, and at least one of the curated models comprises data representing a biological structure and rig that defines animation dynamics for the biological structure, and
instructions executable by the processor to cause the system to tailor at least one of the digital assets based on data received to the system related to an education level of a user; and
navigating on the electronic display device through at least one of the digital assets in order to view a component or process of the cell.

2. The method of claim 1, further comprising searching for and retrieving the at least one of the visualizations based on subject matter.

3. The method of claim 1, further comprising performing a search for a biological concept, thereby causing the system to display a subset of the plurality of interconnected digital assets that relate to the biological concept.

4. The method of claim 1, wherein the navigating comprises choosing at least one option, thereby causing the system to select the at least one digital asset for display.

5. The method of claim 1, wherein navigating comprises choosing at least one option, thereby causing the system to present a further choice, further wherein a series of choices causes the system to display a subset of the plurality of interconnected digital assets.

6. The method of claim 1, wherein the at least one of the digital assets is selected for display by the system based on an educational standard.

7. The method of claim 1, wherein a subset of the plurality of interconnected digital assets follows an independent educational standard.

8. The method of claim 1, wherein the plurality of interconnected digital assets is predetermined based on an educational standard.

9. The method of claim 1, wherein the plurality of interconnected digital assets define a lesson plan.

10. The method of claim 1, further comprising viewing information about the source of the supporting data for each digital asset.

11. The method of claim 1, further comprising viewing a first model of a biological phenomenon and viewing a second, competing model of the biological phenomenon.

12. The method of claim 1, wherein navigating includes changing one or more parameters of a cellular process.

13. The method of claim 12, wherein the parameters include one selected from the group consisting of temperature, pH, [O₂], pressure, salinity, and a combination thereof.

14. The method of claim 12, further comprising viewing a reaction of a biological system in response to the change of one or more parameter.

15. The method of claim 1, wherein the plurality of interconnected digital assets have a consistent visual style.

16. The method of claim 1, further comprising navigating through the at least one of the digital assets at a first level of complexity corresponding to a first educational level and at a second level of complexity corresponding to a second educational level.

17. The method of claim 1, wherein the at least one of the digital assets depicts an interaction of at least two biological entities.

18. The method of claim 1, wherein the at least one of the digital assets depicts one selected from the list consisting of: a protein in a plurality of realistic conformations; a signaling pathway comprising a plurality of biomolecules at least two of which interact only indirectly; and molecular crowding.

19. The method of claim 1, further comprising viewing the digital assets via a web browser on the user electric display device.

20. The method of claim 1, wherein the system further comprises a plurality of digital assets that visually depict experimental procedures used to study the cell.

21. The method of claim 1, wherein the system further comprises an assessment tool.

22. The method of claim 21, wherein the assessment tool is associated with the plurality of digital assets.

23. The method of claim 22, wherein the assessment tool is embedded within the plurality of digital assets.

24. The method of claim 21, further comprising a digital badging system that is operably connected to the assessment tool.

25. The method according to claim 21, further comprising assessing a user via the assessment tool.

26. The method of claim 1, wherein at least one of the digital assets depicts a cross-section of the cell and navigating comprises a user clicking through different components of the cell.

27. The method of claim 21, wherein the assessment tool allows a student to perform at least one task selected from the group consisting of: visually modify existing digital assets; order digital assets to properly sequence a temporal process; create their own custom digital asset within the system; control parameters that impact quantitative and/or qualitative output of digital assets; and a combination thereof.

28. The method according to claim 1, wherein the system is configured to allow an instructor to engage one or more students in an interactive manner.

29. The method according to claim 1, wherein the system is configured to allow more than one student access at a single time, such that students can collaborate together within the system.

30. The method according to claim 1, wherein the system is configured to allow an instructor to monitor student progress and understanding within and across individual digital assets.

31. The method according to claim 30, wherein the system is further configured to allow an instructor to guide students in implementing asset-based activities in a flipped-classroom context.

32. The method according to claim 1, the system is configured to receive updates based on changing scientific data or shifting theories within the scientific community, and to perform at least one task selected from the group consisting of: update one or more digital assets based on the changing scientific data or the shifting theories within the scientific community; delete one or more digital assets based on the changing scientific data or the shifting theories within the scientific community, create one or more new digital assets, based on the changing scientific data or the shifting theories within the scientific community; and a combination thereof.
